(19) United States
(12) Patent Application Publication
(10) Pub. No.: US 2024/0050931 A1
(43) Pub. Date: Feb. 15, 2024

(54) SOLID POROUS PENTACIL-ZEOLITE COMPOSITE MATERIALS

(71) Applicant: The University of Connecticut, Farmington, CT (US)

(72) Inventor: Pu-Xian Gao, Coventry, CT (US)

(21) Appl. No.: 18/234,099

(22) Filed: Aug. 15, 2023

Related U.S. Application Data
(60) Provisional application No. 63/398,206, filed on Aug. 15, 2022.

(51) Int. Cl. B01J 29/46; B01J 23/75; B01J 35/04; B01J 35/00; B01J 35/10; B01J 37/02; B01D 53/86

(52) U.S. Cl. CPC B01J 29/46; B01J 23/75; B01J 35/04; B01J 35/006; B01J 35/1019; B01J 35/1014; B01J 35/1038; B01J 37/0217; B01J 37/0219; B01J 37/0228; B01J 37/0244; B01D 53/864; B01D 2257/702; B01D 2255/504; B01D 2255/20746; B01D 2255/9202; B01D 2255/9207; B01D 2255/9205

(57) ABSTRACT

Solid porous composite ZSM-5 materials comprising a generally vertical orientation of an array of pentacil-zeolite crystals on a porous substrate.

### CROSS-REFERENCE TO RELATED APPLICATIONS

This application claims priority to U.S. Provisional Application No. 63/398,206, filed Aug. 15, 2022, the entirety of which is incorporated into this application by reference.

### STATEMENT REGARDING FEDERALLY SPONSORED RESEARCH

This invention was made with government support under Grant No. DE-EE0006854, awarded by the Department of Energy, and Grant Nos. CBET1344792 and IIP1919231, awarded by the National Science Foundation. The government has certain rights in the invention.

### BACKGROUND

Solid porous materials, such as activated carbon, metal oxides, zeolites, and metal-organic frameworks (MOFS), have been applied in a number of applications, including catalysis, membrane separation, and sensing. These porous materials have high surface area, ordered structures, adjustable chemical compositions, and selective diffusion characteristics. Such properties allow the materials to perform multiple functions in a single application, including catalysis, adsorption, separation, and capture of various gases and liquids.

Significant research has been devoted to enhancing the performance of solid porous materials. Efforts have been made to maximize catalytic conversion efficiency, adsorption uptake, and separation ability. Less attention has been devoted to solving problems associated with kinetic restrictions, which may play a significant role in transient reactions or processes of short duration that demand high energy-efficiency and fast diffusion kinetics. For instance, low-temperature hydrocarbon (HC) traps have been found useful during the automotive cold-start period prior to the thermal activation of three-way catalysts (TWCs) or diesel oxidation catalysts (DOCs). The transition stage of a cold-start period is usually less than three minutes. During this abbreviated stage, unburnt HCs can be released despite downstream performance of an efficient HC trap. These short-duration processes demand a solution to kinetic restraints of existing solid porous materials.

Research has demonstrated that manipulating the orientation and hierarchical structure in porous materials and nanostructure assemblies may provide a potential solution. For example, metal-oxide nanoarrays based on monolithic catalysts have been developed for various heterogeneous reactions ranging from the oxidation of CO, CH₄, HCs, NO, and soot, to NOx reduction and CO₂ hydrogenation. In general, catalytic performance was controllable by tuning porosity and the orientation of the nanoarrays. It has also been verified that mass transport occurs in nanoarray-based monolithic catalysts, which lowers internal diffusion limitations.

There are numerous current drawbacks associated with practically using solid porous materials and nanoarray-type structures in applications such as catalytic converters. For one, it is difficult to control the anisotropic distribution of pores and channels in materials such as zeolites. Macroscopically engineering specific array structures and producing preferential growth of nanocrystals is also difficult to control. These difficulties in turn create performance limitations with respect to maximizing pore exposure and adsorption of a liquid or gas such as an HC.

Zeolites offer an attractive option for preparing improved and highly functional solid porous nanomaterials. One such zeolite, known as Zeolite Socony Mobil-5 (“ZSM-5”), is an aluminosilicate zeolite belonging to the pentasil family with the chemical formula, NaₙAlₙSi₉₆₋ₙO₁₉₂·16H₂O (0<n<27). ZSM-5 was patent by Mobil Oil Company in 1975 (see U.S. Pat. No. 3,702,886) and has since been widely used in the petroleum industry as a heterogeneous catalyst for hydrocarbon isomerization reactions. The zeolite includes several pentasil units (eight five-membered rings) linked together by oxygen bridges to form pentasil chains. The vertices are Al or Si and an O is believed to be bonded between the vertices. The pentasil chains are interconnected by oxygen bridges to form corrugated sheets with ten-ring holes. Each ten-ring hole has Al or Si as vertices with an O believed to be bonded between each vertex.

Each corrugated sheet is connected by oxygen bridges to form a structure with “straight” ten-ring channels running parallel to the corrugations and sinusoidal ten-ring channels perpendicular to the sheets. Adjacent layers of the sheets are related by an inversion point. The estimated pore size of the channel running parallel with the corrugations is 5.4-5.6 Å. The crystallographic unit cell of ZSM-5 has 96 T sites (Si or Al), 192 O sites, and a number of cations depending on the Si/Al ratio. The structure is orthorhombic (space group Pnma) at high temperatures but a phase transition to the monoclinic space group P2₁/n.1.13 occurs on cooling below a transition temperature, located between 300 and 350 K.

While the chemistry of ZSM-5 has been fairly well understood for some time, tailoring ZSM-5-based nanostructures has proven difficult. Particularly for applications aimed at addressing kinetic limitations of solid porous materials, a suitable high surface area ZSM-5 framework is needed. In general, a ZSM-5 framework structure is dependent on its manner of growth. A need in the art exists for improvements to ZSM-5-based nanostructures, particularly for improvements that address lack of adequate surface area, pore volume, and reaction kinetics for fast-duration processes for example.

### SUMMARY

One embodiment of the solid porous ZSM-5 composite material includes an array of pentasil-zeolite crystals on a surface of a substrate. The array of pentasil-zeolite crystals are oriented elongate along a longitudinal c-axis that is generally perpendicular to the surface of the substrate. The array of pentasil-zeolite crystals defines a plurality of a-channels and a plurality of b-channels. The plurality of b-channels has a first flow path that is generally parallel to the surface of the substrate. The plurality of a-channels has a second flow path that follows an axis that crosses and is generally perpendicular to the first flow path.

Another embodiment of the solid porous composite material further includes an additional array of a metal oxide having channels in fluid communication with the plurality of a-channels and the plurality of b-channels of the array of pentasil-zeolite crystals.

The solid porous composite material can be made by a method that includes: providing a seeded substrate and contacting the seeded substrate with a mixture of an alkoxide of silicon, and an aluminate, at a molar ratio of 10:1 to 30:1 (alkoxide of silicon:aluminate) under conditions sufficient to form the solid porous composite material.

The solid porous ZSM-5 composite material has a variety of applications, including hydrocarbon adsorption and catalysis (e.g., hydrocarbon oxidation). One application involves a method of removing a hydrocarbon from a fluid by contacting the fluid with the solid porous composite material under conditions sufficient to adsorb the hydrocarbon onto the solid porous composite material. The adsorbed hydrocarbon can be further trapped or oxidized, efficiently reducing hydrocarbon emissions across a wider temperature window than that observed with conventional catalytic systems.

### BRIEF DESCRIPTION OF THE DRAWINGS

The foregoing summary, as well as the following description of the disclosure, is better understood when read in conjunction with the appended drawings. For the purpose of illustrating the disclosure, the drawings illustrate some, but not all, alternative embodiments. This disclosure is not limited to the precise arrangements and instrumentalities shown. The following figures, which are incorporated into and constitute part of the specification, assist in explaining the principles of the disclosure.

FIG. 1A is a schematic illustration showing a flat ZSM-5 membrane desired for separation and corresponding molecular channel distribution within membranes.

FIG. 1B is a schematic illustration showing a c-oriented (vertically oriented relative to the substrate) ZSM-5 single crystal array film with exposure of molecular channels along what are shown as both a- and b-axes, respectively, to provide adequate active centers for adsorption.

FIG. 2 is a schematic of the synthesis process of ZSM-5 films on the cordierite substrate. I. Seeding process on bare cordierite substrate by dip-coating self-prepared silicalite-1 seeds; II. Growth of ZSM-5 films at different Si/Al ratios of 80 Si:1 Al (“Z-80-F”) and 20 Si: 1 Al (“Z-20-A”) on the seeded substrate.

FIG. 3 is a plot of the X-ray diffraction patterns of the conventional continuous ZSM-5 film (Z-80-F) and array-structured ZSM-5 film (Z-20-A).

FIG. 4A-B are images showing top-view scanning electron microscope (SEM) images of blank cordierite (FIG. 4A) and seeded cordierite (FIG. 4B). The calculated particle size distribution of silicalite-1 seeds is inserted in the image (b). The channel surface of cordierite monolith is covered by silicalite-1 seeds in a diameter of ˜70 nm.

FIGS. 5A-B are SEM images from top view and cross-sectional view (inset) of Z-80-F (FIG. 5A) and Z-20-A films (FIG. 5B).

FIGS. 5C-D are cross-sectional bright-field TEM images of Z-80-F (FIG. 5C) and Z-20-A films (FIG. 5D).

FIGS. 5E-F are corresponding high-resolution TEM images and selected area electron diffraction (SAED) patterns (inset) of Z-80-F (FIG. 5E) and Z-20-A (FIG. 5F) films.

FIGS. 6A-B are scanning electron microscope (SEM) images of array-structured ZSM-5 film (Z-20-A) from a top view (FIG. 6A) and a cross-sectional view (FIG. 6B), indicating a uniform distribution of ZSM-5 nanorods integrated on the cordierite surface.

FIGS. 7A-J are scanning electron microscope (SEM) images showing top views of conventional continuous ZSM-5 films (Z-80-F) (FIG. 7A-E) and array-structured ZSM-5 films (Z-20-A) (FIG. 7F-J) synthesized at 180° C. for 3, 6, 12, 18 and 24 h. Scale bars: 5 μm.

FIG. 8 are scanning electron microscope (SEM) images showing cross-sectional views of conventional continuous ZSM-5 films (Z-80-F) (FIG. 8A-E) and array-structured ZSM-5 films (Z-20-A) (FIG. 8F-J) synthesized at 180° C. for 3, 6, 12, 18 and 24 h. Scale bars: 5 μm.

FIG. 9 is a representative plot showing the weight increase ratio of conventional ZSM-5 film (Z-80-F) and array-structured ZSM-5 film (Z-20-A) synthesized at 180° C.

FIG. 10A is a plot showing representative nitrogen adsorption-desorption isotherms for the as-prepared ZSM-5 film (Z-80-F) and array structured ZSM-5 film (Z-20-A).

FIG. 10B is a plot showing representative pore-size distributions as derived by BJH method for as-prepared, conventional ZSM-5 films (Z-80-F) and array-structured ZSM-5 films (Z-20-A).

FIGS. 10C-D are plots showing representative data of ammonia temperature-programmed desorption (NH₃-TPD) of HZ-80-F (FIG. 10C) and HZ-20-A (FIG. 10D).

FIG. 11A is a plot showing representative data for propene adsorption and desorption of proton-exchanged continuous ZSM-5 film (HZ-80-F) and array-structured ZSM-5 film (HZ-20-A) as a function of time. Each sample was maintained at 100° C. for 30 min under a gas mixture of 333 ppm C₃H₆+12% O₂/N₂, and then heated to 600° C. at a ramp rate of 20° C.·min⁻¹ without C₃H₆. Space velocity was 24,000 h⁻¹.

FIG. 11B is a bar graph showing representative propene adsorption capacity for continuous ZSM-5 film (HZ-80-F) and array-structured ZSM-5 film (HZ-20-A). Each sample was maintained at 100° C. for 30 min under a gas mixture of 333 ppm C₃H₆₊₁₂% O₂/N₂, and then heated to 600° C. at a ramp rate of 20° C.·min⁻¹ without C₃H₆. Space velocity was ˜24,000 h.

FIG. 11C is a plot showing the representative adsorption rate (1^{st} order derivative of time-dependent C₃H₆ concentration change, ppm·min−1) of HZ-80-F and HZ-20-A. Each sample was maintained at 100° C. for 30 min under a gas mixture of 333 ppm C₃H₆+12% O₂/N₂, and then heated to 600° C. at a ramp rate of 20° C.·min⁻¹ without C₃H₆. Space velocity was ˜24,000 h⁻¹.

FIG. 12 is a plot showing representative thermogravimetric analysis (TGA) results of HZ-80-F and HZ-20-A after the adsorption under 333 ppm C₃H₆+12% O₂/N₂ at 100° C. for 30 min.

FIGS. 13A-B are plots showing representative in-situ diffuse reflectance infrared Fourier transform spectroscopy (DRIFTS) spectra of proton-exchanged conventional ZSM-5 film (HZ-80-F) (FIG. 13A) and proton-exchanged array-structured ZSM-5 film (HZ-20-A) (FIG. 13B) during the propene adsorption under 333 ppm C₃H₆+12% O₂/N₂ at 100° C. for 30 min.

FIG. 13C is a plot showing representative relative integration area of H-bonded C₃H₆ (1470 cm⁻¹) from DRIFTS spectra during the propene adsorption at 100° C. for 30 min.

FIGS. 13D-E are plots showing representative in-situ diffuse reflectance infrared Fourier transform spectroscopy (DRIFTS) spectra of proton-exchanged conventional ZSM-5 film (HZ-80-F) (FIG. 13D) and proton-exchanged array-structured ZSM-5 film (HZ-20-A) (FIG. 13E) during the propene adsorption under 333 ppm C₃H₆+12% O₂/N₂ at 100° C. for 30 min.

FIG. 13F is a plot showing representative relative integration area of CH₂—/CH₃-(3080-2750 cm⁻¹) from DRIFTS spectra during the propene adsorption at 100° C. for 30 min.

FIGS. 14A-B are plots showing representative in-situ diffuse reflectance Fourier transform spectroscopy (DRIFTS) of proton-exchanged conventional ZSM-5 film (HZ-80-F) (FIG. 14A) and proton-exchanged array-structured ZSM-5 film (HZ-20-A) (FIG. 14B) during the temperature increase from 100° C. to 450° C. at 2° C.·min⁻¹ in 12% O₂/N₂.

FIG. 14C is a plot showing representative relative integration area of H-bonded C₃H₆ (1470 cm⁻¹) from DRIFTS spectra during the temperature ramping period.

FIG. 14D-E are plots showing representative in-situ diffuse reflectance Fourier transform spectroscopy (DRIFTS) of proton-exchanged conventional ZSM-5 film (HZ-80-F) (FIG. 14D) and proton-exchanged array-structured ZSM-5 film (HZ-20-A) (FIG. 14E) during the temperature increase from 100° C. to 450° C. at 2° C.·min⁻¹ in 12% O₂/N₂.

FIG. 14F is a plot showing representative relative integration area of CH₂—/CH₃-(3080-2750 cm⁻¹) from DRIFTS spectra during the temperature ramping period.

FIG. 15 are representative top view (FIG. 15A) and cross-sectional view (FIG. 15B) scanning electron microscope (SEM) images of Co₃O₄ nanoarray grown on the cordierite surface. Scale bars: 5 μm.

FIG. 16A is a schematic of the designed dual-bed reactor system for cold start test (CST) including either HZ-80-F or HZ-20-A as propene trap (front) and Co₃O₄ nanoarray as propene oxidation catalyst (back). Scale bar is 5 μm.

FIG. 16B is a plot showing representative CST results depending on the test time. Each sample was kept at 100° C. for 3 min and then heated to 600° C. by 20° C.·min⁻¹. Space velocity was ˜24,000 h.

FIG. 16C is a plot showing representative data for propene conversion efficiency vs. reaction temperature of different configurations (only Co₃O₄, HZ-80-F+Co₃O₄, and HZ-20-A+Co₃O₄) under a gas mixture of 333 ppm C₃H₆+12% O₂/N₂. Each sample was kept at 100° C. for 3 min and then heated to 600° C. by 20° C.·min⁻¹. Space velocity was −24,000 h⁻¹.

FIG. 17 is a schematic illustration of the synthesis process of hybrid structured ZSM-5 and Co₃O₄ nano-array and their individual component integrated on cordierite honeycomb monolith. FIG. 17A shows a Cordierite/Co₃O₄ nano-array, FIG. 17B shows a Cordierite/ZSM-5 nano-array, FIG. 17C shows a hybrid Cordierite/ZSM-5/Co₃O₄ nano-array, and FIG. 17D shows a hybrid Cordierite/Co₃O₄/ZSM-5 nano-array.

FIG. 18 shows representative SEM images from (FIG. 18A-D) top view and (FIG. 18E-H) cross-sectional view of as-prepared (FIG. 18A, FIG. 18E) Cordierite/Co₃O₄ nano-array, (FIG. 18B, FIG. 18F) Cordierite/ZSM-5 nano-array, (FIG. 18C, FIG. 18G) hybrid Cordierite/ZSM-5/Co₃O₄ nano-array, and (FIG. 18D, FIG. 18H) hybrid Cordierite/Co₃ SM-5 nano-array.

### DETAILED DESCRIPTION

As briefly described above, a ZSM-5 framework includes sinusoidal channels along an a-axis and straight channels along b-axis. In general, continuously b-oriented thin films of ZSM-5 materials are desired for separation of molecules such as HCs from liquid or gas due to faster diffusion rates through the short and straight channels along the b-axis. Upon adsorption, the guest species can be captured in both a- and b-channels and their intersections in ZSM-5 crystals. Maximizing the exposure of a- and b-channels is difficult, however, because the orientation of a ZSM-5 framework is correlated to the manner in which the nanoarray is grown. The inventors have developed new methods for growing novel ZSM-based nanoarrays that present in a vertical orientation relative to a substrate. The methods provide for a nanoarray with increased surface area and pore volume, which in turn improves reaction kinetics.

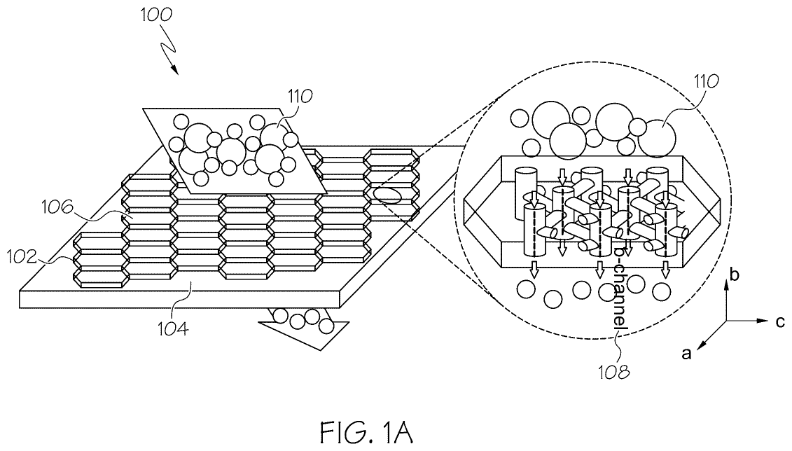

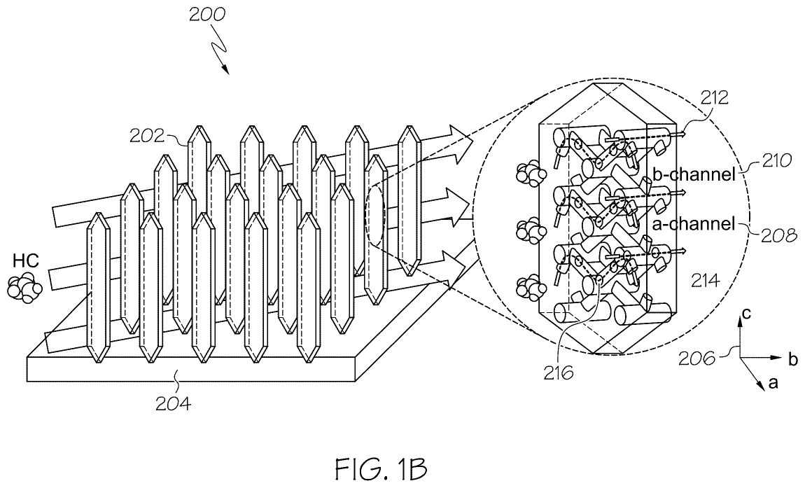

One method for growing ZSM-5 films involves contacting a substrate with a mixture such as a solution having a relatively high ratio of an alkoxide of silicon and an aluminate. This provides for a relatively high Si:Al ratio in the resulting pentasil zeolite crystal, creating a dense crystal formation laying flat on the substrate. A composite material 100 prepared by such a method is depicted in FIG. 1A. The nanostructure of the composite 100 has an array 102 of pentasil-zeolite crystals 106 grown on the substrate 104. The array 102 is oriented along a horizontal c-axis that is parallel to the surface of the substrate 104. When the composite 100 is exposed to a liquid or gas for separation or catalytic purposes, the desired guest molecules 110 (HCs, for example) flow through the nanoarray 102 primarily through a b-channel path 108 that follows the b-axis, perpendicular to the vertically oriented c-axis. As a result, predominate exposure sites are limited to the straight, b-channel pores, and access to the sinusoidal a-channel pores is limited. The inventors surprisingly discovered that by lowering the Si:Al ratio in the mixture used to grow the pentasil-zeolite crystals, a vertically oriented array of separated nanorod crystals can be formed. The vertically oriented array increases specific surface area and mesopore volume and in turn improves the reaction kinetics of the composite material when used in applications such as HC adsorption.

I. Structure and Composition of ZSM-5 Composite

An embodiment of the ZSM-5 composite is depicted in FIG. 1B. The ZSM-5 composite 200 includes an array of pentasil zeolite-crystals 202 on a surface of a substrate 204. The array of pentasil zeolite-crystals 202 is oriented elongate along a longitudinal c-axis 206 that is generally perpendicular to the surface of the substrate 204. The array of pentasil-zeolite crystals 202 define a plurality of a-channels 208 and a plurality of b-channels 210. The plurality of b-channels 210 have a first flow path 212 that is generally parallel to the surface of the substrate 204. The plurality of a-channels 208 have a second sinusoidal or undulating flow path 216 that follows an axis that crosses and is generally perpendicular to the first flow path 212. The terms “generally perpendicular” and “generally parallel” refer to orientations that are exactly perpendicular or parallel (90 or 0 degrees, respectively, plus or minus 30 degrees, e.g., ±25 degrees, ±20 degrees, ±15 degrees, ±10 degrees, or ±5 degrees off from exactly perpendicular or parallel. The orientation array features in the pentasil zeolite-crystals can be determined by known scanning electron microscopy (SEM) or X-ray diffraction techniques. The geometry of the ZSM-5 nanoarray is in general suitable for any surface (internal or external) on a variety of complex structures such as catalytic converters. The substrate can be a variety of substrates, including a porous substrate such as monolithic catalyst support. An example is a ceramic cordierite monolith.

In one embodiment, the array of pentasil-zeolite crystals can have an individual crystal diameter ranging from 10 nm to 500 nm. In another embodiment, the array of pentasil-zeolite crystals can have an individual crystal diameter ranging from 20 nm to 400 nm. In a further embodiment, the array of pentasil-zeolite crystals can have an individual crystal length ranging from 100 nm to 10 μm. In another embodiment, the array of pentasil-zeolite crystals can have an individual crystal length ranging from 200 nm to 8 μm. Individual crystal diameters and lengths can be determined by known microscopy techniques. The solid porous ZSM-5 composite materials are in general less dense than typical materials with pentasil-zeolite crystals laying relatively flat on a substrate. In some embodiments, the array of crystals constitutes 1% to 30% by weight of the solid porous ZSM-5 composite material. In a further embodiment, the array of crystals constitutes 15% to 20% by weight of the solid porous ZSM-5 composite material.

Specific surface area of the composite materials is also improved relative to frameworks grown flat on a substrate such as the one depicted in FIG. 1A. In one embodiment, the array of pentasil-zeolite crystals has a specific surface area of 300 m²/g to 400 m²/g. In another embodiment, the array of pentasil-zeolite crystals has an external surface area of 100 m²/g to 200 m²/g. Mesopore volume is also improved. In one embodiment, the array of pentasil-zeolite crystals has a mesopore volume of 0.02 cm³/g to 0.4 cm³/g.

II. Method of Making ZSM-5 Composite

In general, the array of pentasil-zeolite crystals of the solid porous composite can be grown onto a seeded substrate from a mixture (e.g., a solution) with a reduced Si:Al ratio, to give a less dense and vertically oriented array of pentasil-zeolite crystals on the surface of the substrate. Reducing the Si:Al ratio unexpectedly resulted in an improved array morphology and performance. A seeded substrate can be contacted with a mixture of an alkoxide of silicon and an aluminate at a molar ratio of 10:1 to 30:1 (alkoxide of silicon:aluminate) under conditions sufficient to form the solid porous composite material. Specific non-limiting molar rations include molar ratios of 15:1 to 25:1, 18:1 to 22:1, and in one specific aspect, 20:1.

The seeded substrate can be any those substrates described above which are seeded in a manner to permit growth of the array of pentasil-zeolite crystals. The growth method can be carried out at elevated temperatures and times to permit sufficient growth (e.g., 180° C. for 24 hours). The seeded substrate can be a seeded monolithic catalyst support, typically porous, such a seeded ceramic cordierite monolith. The seed can be a silicon dioxide, such as a silicalite (e.g., silicalite-1).

The alkoxide of silicon in the growth mixture can vary. Examples include tetraethyl orthosilicate among other known alkoxides of silicon. Similarly, a variety of aluminates can be used, including metal aluminates such as sodium aluminate. In some aspects, the growth mixture also includes a peptizing and/or a hydrolyzing agent, both of which can aid in growing the array of pentasil-zeolite crystals. Suitable peptizing agents include tetraalkyl ammonium hydroxides, such as tetrapropyl ammonium hydroxide. Suitable hydrolyzing agents include a metal hydroxide, such as sodium hydroxide. In some aspects, the ratio of the alkoxide of silicon and the peptizing agent can range from 5:1 to 90:1 (alkoxide of silicon:peptizing agent). In further aspects, the ratio of the alkoxide of silicon and the hydrolyzing agent can range from 1:1 to 5:1 (alkoxide of silicon:hydrolyzing agent), e.g., 1:0.6.

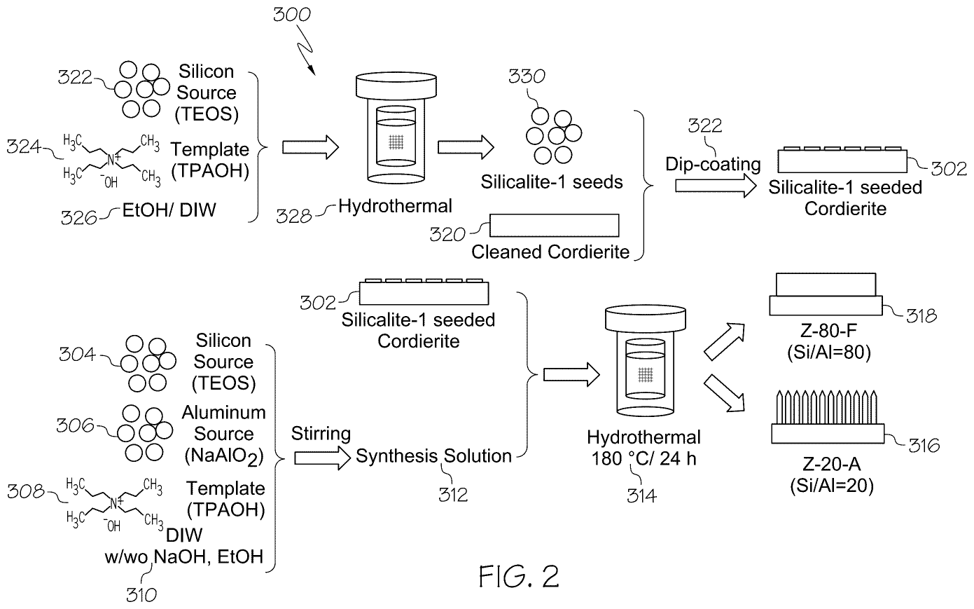

An exemplary method for making the ZSM-5 composite is depicted in FIG. 2. First, a seeded substrate 302 is provided. A suitable seeded substrate is a silicalite-1 seeded substrate. To prepare the seeded substrate, a template 324 such as tetrapropylammonium hydroxide (TPAOH) and a silicon source 322 such as tetraethyl orthosilicate (TEOS) in a suitable solvent 326 such as ethanol and water can be provided as a pre-mixture. The pre-mixture can then be subjected to hydrothermal conditions 328 such as in an autoclave to react the components and thereby provide seeds 330 such as silicate-1 seeds. A cleaned substrate 320 such as a cleaned cordierite substrate can then be exposed to the seeds 330 in a coating step 322, which can be a solution-processing step such as dip coating. The seeded substrate 302 can then be isolated.

Orientation and morphology of the ZSM-5 array can be affected by the ratio of the silicon source 304, aluminum source 306, and template 308 used to grow the array. A silicon sources 304 such as TEOS, an aluminum source 306 such as NaAlO₂, and a template 308 such as TPAOH can be provided as a mixture in a suitable liquid 310 such as water, ethanol, with optional base such as sodium hydroxide. The resulting mixture can then be exposed as a synthesis solution 312 to the seeded substrate 302. Upon hydrothermal synthesis 314 under suitable reaction conditions, either a flat-like ZSM-5 composite 318 or vertically oriented composite 316 can be formed, again depending on ratios of the silicon and aluminum source in the starting mixture.

III. Hybrid Composite and Methods of Making

The embodiment depicted in FIG. 1B is useful for hydrocarbon adsorption among other applications. Additional embodiments can feature a hydrocarbon trap in addition to the adsorbent array of pentasil-zeolite crystals, i.e., a hybrid composite. Thus, in one embodiment, the solid porous composite material further includes an array of a metal oxide having channels in fluid communication with the plurality of a-channels and the plurality of b-channels of the array of pentasil-zeolite crystals. The addition of a metal oxide layer can function as an oxidation catalyst to oxidize hydrocarbons captured by the array of pentasil-zeolite crystals.

An additional array of metal oxide can have any configuration relative to the array of pentasil-zeolite crystals, including a configuration in which the array of pentasil-zeolite crystals is between the surface of the substrate and the array of the metal oxide, i.e., the layer of metal oxide can be grown on top of the array of pentasil-zeolite crystals. A variety of catalytic metal oxides can be used, including cobalt oxides (e.g., Co₃O₄), titanium oxides (e.g., TiO₂, or a titanate such as Mg₂TiO₄), among other metal oxides such as NiO, CeO₂, Ga₂O₃, MnO₂, and ZnO.

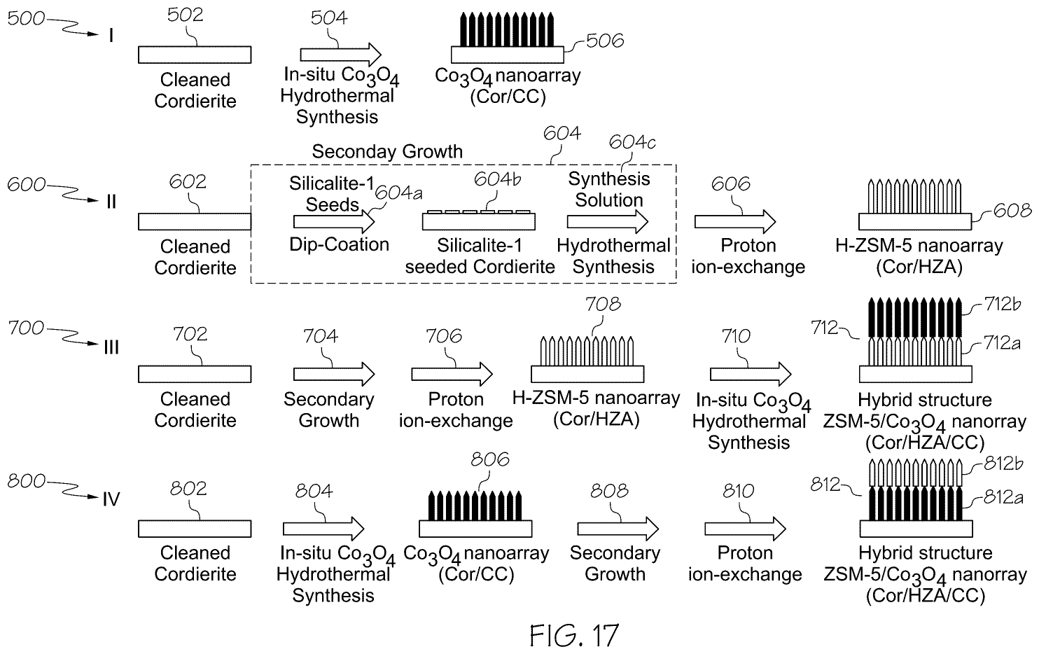

FIG. 17 illustrates several methods for preparing hybrid composites. In general, the synthesis can be completed by the sequential growth of a ZSM-5 nano-array via a secondary growth method and growth of a metal oxide (e.g., Co₃O₄) nano-array via an in-situ hydrothermal method. The two different arrays in hybrid nano-array system can be modulated by adjusting the growth sequence of each component. In one example in which the metal oxide layer is in between the substrate and the ZSM-5 array, the method 500 can involve sequential synthesis. A metal oxide array composite 506, such as a Co₃O₄ composite, can be first grown on a cleaned substrate 502 such as cordierite by an in-situ hydrothermal synthesis step 504. This starting array composite can then be used to prepare an additional ZSM-5 array layer by adapting the method shown in FIG. 2.

Another method 800 involves an in-line or in-situ method. A cleaned substrate 802 such as cordierite can be subjected to in-situ metal oxide hydrothermal synthesis 804 to provide an intermediate nanoarray 806. The intermediate nanoarray 806 can then be subjected to secondary growth 808, and in some embodiments, a proton ion-exchange step 810 (creating acidic sites in the array), to provide a hybrid structure 812, which includes a first metal oxide array 812a and a second ZSM-5 array 812b.

An inverted configuration can likewise be prepared. In one method 600, a cleaned substrate 602 is subjected to a seeding step 604a to provide a seeded substrate 604b. The seeded substrate can then undergo hydrothermal synthesis 604c and optionally a proton ion-exchange step 606 to yield a starting ZSM-5 nanoarray 608 with acidic sites. This starting ZSM-5 nanoarray 608 can then be subjected to additional growth of a metal oxide layer on top of the ZSM-5 layer. Alternatively, an in situ process 700 involves starting with a cleaned substrate 702, followed by growth 704 and proton ion-exchange 706 steps to provide a ZSM-5 nanoarray 708 with acidic sides, which can then be subjected to in situ metal oxide array synthesis 710, for example by hydrothermal synthesis of Co₃O₄. The result is the hybrid composite 712 featuring the acidic ZSM-5 nanoarray 712a in between the substrate and the metal oxide nanoarray 712b.

IV. Applications of Composite and Hybrid Composite

The ZSM-5 composites and hybrid composites can be used in a variety of applications. In one example, the composite can be used to remove a hydrocarbon from a fluid such as a gas (e.g., the atmosphere) by contacting the fluid with the composite under conditions sufficient to adsorb the hydrocarbon onto the composite. With the embodiment that includes the additional metal oxide layer, once captured, the hydrocarbon can be oxidized to reduce hydrocarbon emissions. In general, any hydrocarbon can be adsorbed or trapped (oxidized) with the disclosed composites, including hydrocarbons typically emitted from internal combustion engines (e.g., ethylene, toluene, acetylene, xylenes, benzene, propene, pentane, among others).

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

### EXAMPLES

The following examples further illustrate this disclosure. The scope of the disclosure and claims is not limited by the scope of the following examples.

I. Materials and Methods

A. Materials

Cordierite (400 cpsi, Corning Inc.) was used as the substrate for the sample preparation. To synthesize ZSM-5 films, tetrapropylammonium hydroxide solution (TPAOH, 25 wt. % in water, ACROS), tetraethyl orthosilicate (TEOS, 98%, ACROS), sodium aluminate (NaAlO₂, 92%, Fisher Scientific), and sodium hydroxide (NaOH, pellets, ACROS) were purchased. Ammonium nitrate (NH₄NO₃, Fisher Scientific) was used for the proton ion exchange purpose. Cobalt chloride hexahydrate (CoCl₂·6H₂O, ACROS) and urea ((NH₂)₂CO, Fisher Scientific) were used for the synthesis of Co₃O₄ nanoarray.

B. Synthesis of ZSM-5 Films at Different Si/Al Ratios

ZSM-5 films at different Si/Al ratios (SA, 20, i.e., 20 Si: 1 Al, or 80, i.e., 80 Si: 1:Al) were hydrothermally synthesized on the cordierite substrate by secondary growth method. The synthesis process is shown in FIG. 2, including the preparation of silicalite-1 seeds, deposition of silicalite-1 seeds on the cordierite surface by dip coating, and the following hydrothermal synthesis of ZSM-5 films.

The silicalite-1 seeds were prepared using the following procedure. First, 25.8 g TPAOH (25 wt. % in water) and 21.5 g ethanol (EtOH) were mixed under magnetic stirring at a rate of 500 rpm. Then, 24.3 g TEOS was gradually added by droplets into the pre-mixed solution. After mixing at 30° C. for 6 h, the as-prepared solution was transferred into a Teflon lined stainless steel autoclave for the reaction at 100° C. for 72 h. The final solution was stored in a refrigerator for the following seeding purpose.

The obtained silicalite-1 seeds solution was diluted by 10 times with 430 H₂O/100 EtOH (vol. %) for the following seeding purpose. A piece of pre-cleaned cordierite substrate with a dimension of 2 cm×2 cm×1 cm was submerged into the diluted seeding solution while being sonicated for 30 s in a sonicator (Branson 5510, 42 kHz, 135 W), and then blown by the compressed air to remove extra residual solution. Next, the substrate was dried under microwave irradiation (Sharp R-309yw, 1000 W) for 80 s, and treated in an oven at 350° C. for 5 min to stabilize the seeds deposition. The above dip-coating steps were repeated for 3 times to ensure that the substrate surface was fully covered by a layer of silicalite-1 seeds. Finally, the seeded substrate was calcined at 500° C. for 1 h in a furnace at a ramp rate of 5° C.·min⁻¹.

ZSM-5 films at different Si/Al ratios of 20 and 80 were hydrothermally synthesized on the seeded substrate. In the case of ZSM-5 film at Si/Al=20, a solution mixture with a molar ratio of 1TEOS:0.112TPAOH: 0.05NaAlO₂: 111H₂O: 0.36NaOH: 8EtOH was prepared. 40 mL of the mixture solution was then transferred into a 50 mL Teflon lined stainless steel autoclave, where a piece of pre-seeded cordierite substrate was vertically submerged and suspended in the solution. After reaction at 180° C. for 24 h, the autoclave was quenched by the flowing water to room temperature. Then the sample was withdrawn and sonicated in DI water for 30 min to remove any loosely sedimented crystals, which were nucleated from the bulk solution and then deposited on the support surface. The sample was dried at 110° C. overnight and calcined at 550° C. for 4 h to burn out the occluded template. Following the similar procedures, ZSM-5 film at Si/A1=80 was prepared using a solution of 1TEOS: 0.112TPAOH: 0.125NaAlO₂: 111H₂O. The as-prepared ZSM-5 films at different Si/Al ratios of 20 and 80 were denoted as “Z-20-A” and “Z-80-F”, respectively. In addition, in order to investigate the growth process of different films, samples synthesized at 3, 6, 12, 18 and 24 h were also prepared and marked as “X_Y”, where X represented “Z-20-A” or “Z-80-F”, and Y represented the synthesis time.

The as-prepared ZSM-5 films were ion exchanged with 1 M NH₄NO₃ aqueous solution at 80° C. for 12 h. After that, each sample was dried at 110° C. overnight. The ion exchanged procedures were repeated by 3 times before the final calcination at 500° C. for 4 h (2° C.·min⁻¹). The obtained proton-exchanged ZSM-5 films were denoted as “HZ-20-A” and “HZ-80-F”, respectively.

C. Synthesis of Co₃O₄ Nanoarray-based Monolithic Catalysts

Co₃O₄ nanoarray were in-situ grown on the cordierite surface via a modified solution chemistry strategy. Briefly, 10 mmol CoCl₂ as cobalt precursors and 60 mmol urea were dissolved in 30 ml of distilled water and ultra-sonicated to achieve a clean solution. A piece of pre-cleaned cordierite was suspended into the as-prepared solution for hydrothermal synthesis. The reaction was held at 98° C. for 6 h. After that, the cordierite substrate was rinsed with distilled water and ethanol for several times, dried overnight, and calcined at 350° C. for 2 h at a ramp rate of 5° C.·min⁻¹. The loaded amount of Co₃O₄ nanoarray is ˜10 wt. % of the cordierite.

D. Scanning Electron Microscope and Scanning Transmission Electron Microscope

The morphology and structure of the ZSM-5 films were investigated by a filed-emission scanning electron microscope (SEM, Teneo LVSEM, FEI) at an accelerating voltage of 20 kV and a high-resolution scanning transmission electron microscope (STEM, Talos, FEI; 200 kV) combined with energy dispersive spectroscopy (EDS). The cross-sectional (S)TEM samples were characterized with a Tecnai 30 STEM at an accelerating voltage of 300 kV.

E. X-ray Diffraction

X-ray diffraction (XRD) patterns of the as-prepared ZSM-5 films were acquired on a BRUKER D2 X-ray diffractometer using Cu-Kα radiation (1.5406 Å) operated at 30 kV and 10 mA. The scan range was from 5° to 35° at a scan rate of 2.4° min⁻¹. The value of crystallographic preferred orientation (CPO) is calculated to evaluate the intendancy of the film orientation, expressed by the equation below:

$$CPO ( [ X ] / [ Y ] ) = \frac{{I}_{S}^{[ X ]} / {I}_{S}^{[ Y ]} - {I}_{P}^{[ X ]} / {I}_{P}^{[ Y ]}}{{I}_{S}^{[ X ]} / {I}_{S}^{[ Y ]}} ,$$

Where [X] and [Y] represent the Miller indexes of the crystallographic planes, and I_{S} and I_{P} are the intensities from the ZSM-5 films on cordierite and commercial ZSM-5 powders. The value of CPO([002]/[200]+[020]) would be closer to 1 if the preferential orientation of c-axis dominates in the film.

F. Nitrogen Adsorption-Desorption Isotherms

The N₂ adsorption-desorption isotherms were measured at 77K on a Micromeritics ASAP 2020 volumetric adsorption analyzer to characterize the specific surface area (BET, Brunauer-Emmett-Teller plot) and pore size distribution (BJH, Barrett-Joyner-Halenda model). Each sample was degassed under vacuum at 150° C. for 6 h prior to the measurement in order to remove water and other possible adsorbed species.

G. Ammonia Temperature Programmed Desorption

To determine the acid sites on each sample, ammonia temperature-programmed desorption (NH₃-TPD) was carried out in a homemade horizontal quartz tube reactor. Each sample was pretreated in N₂ flow (200 sccm) at 550° C. for 1 h and then cooled down to 100° C. Then, 1% NH 3 in N₂ (50 sccm) was fed in to saturate the sample for 1 h. The physiosorbed NH₃ was blown away by purging the sample in pure N₂ flow (200 sccm) for 1 h. Subsequently, the sample was heated in N₂ flow from 100° C. to 500° C. at a ramp rate of 10° C.·min⁻¹. The desorbed NH₃ was monitored by a Fourier Transform infrared spectrometer (FTIR, Nicolet 6700, Thermo Scientific).

H. In-Situ Diffuse Reflectance Infrared Fourier Transform Spectroscopy

In-situ diffuse reflectance infrared Fourier transform spectroscopy (DRIFTS) was conducted on a Fourier Transform Infrared Spectrophotometer (FTIR, Nicolet iS-50, Thermo Scientific) equipped with an MCT detector cooled by liquid nitrogen. Specifically, the ZSM-5 film-based monoliths (3×3 channels) were crushed into powders and ground. The sample was pretreated in 12% O₂/N₂ at 500° C. for 1 h to eliminate any potential contaminants, and then cooled down to 100° C. for background spectrum collection. While the spectrum was continuously detected at a resolution of 2 cm⁻¹ for 32 scans, the sample was firstly interacted with 333 ppm C₃H₆₊₁₂% O₂/N₂ at a flow rate of 50 ml min⁻¹ at 100° C. for 30 min, followed by N₂ purge for another 30 min, and finally heated to 450° C. at a rate of 2° C.·min⁻¹.

I. Performance Evaluation of Propene Adsorption

Propene adsorption performance of the as-prepared ZSM-5 films were evaluated following the Low Temperature Storage Catalyst Test Protocol created by USDRIVE in the same setup for NH₃-TPD. Each sample with a volume of 0.7 cm×0.7 cm×1 cm was loaded. After being calibrated for C₃H₆, CO and CO₂, the above-mentioned FTIR system was used to detect the concentration of inlet and outlet gases. Before each test, the sample was pretreated at 600° C. for 20 min under the atmosphere of 12 vol. % O₂+6 vol. % CO₂₊₆ vol. % H₂O in N₂ balance. After the reactor was cooled down to 100° C. in N₂ flow, background FTIR spectrum was collected for the following continuous detection. The feed gas with a composition of 333 ppm C₃H₆₊₁₂ vol. % O₂/N₂ firstly bypassed the reactor for 3 min to ensure a stable concentration, and then switched back to the reactor while the temperature was maintained at 100° C. After 30 min, C₃H₆ was cut off from the feed gas while the reactor was heated to 600° C. with a ramp rate of 20° C.·min⁻¹. The space velocity is set to ˜24,000 h⁻¹.

J. Cold-Start Test

The cold-start tests (CST) on the dual-bed reactor system using HZ-80-F or HZ-20-A adsorber and Co₃O₄ nanoarray oxidation catalyst were performed using the same experiment setup and FTIR in NH₃-TPD as mentioned above. All samples had the same volume in 0.7 cm×0.7 cm×1 cm. The test procedures were similar with the performance evaluation of propene adsorption, except that the adsorption stage at 100° C. was maintained for only 3 min before ramping the temperature, and the gas composition was remained with 333 ppm C₃H₆₊₁₂ vol. % O₂/N₂ throughout the test. The space velocity was set to be ˜24,000 h⁻¹.

II. Synthesis and Characterization of ZSM-5 Films

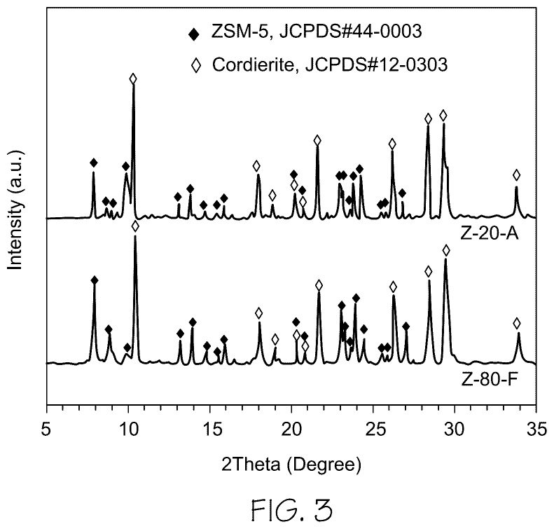

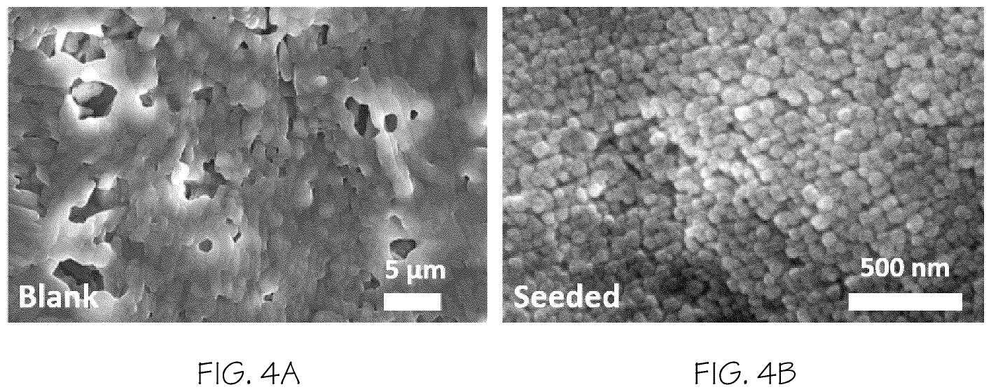

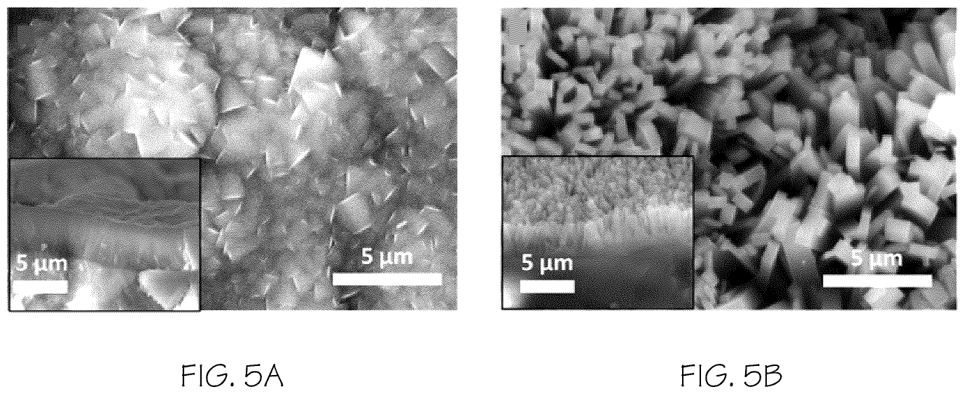

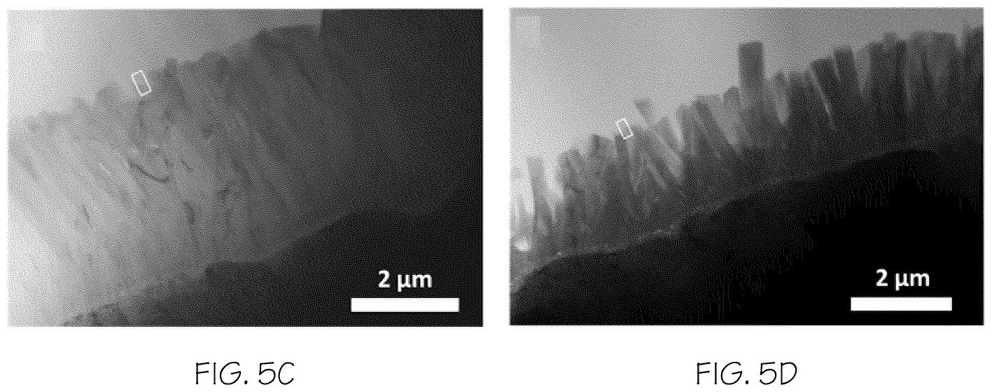

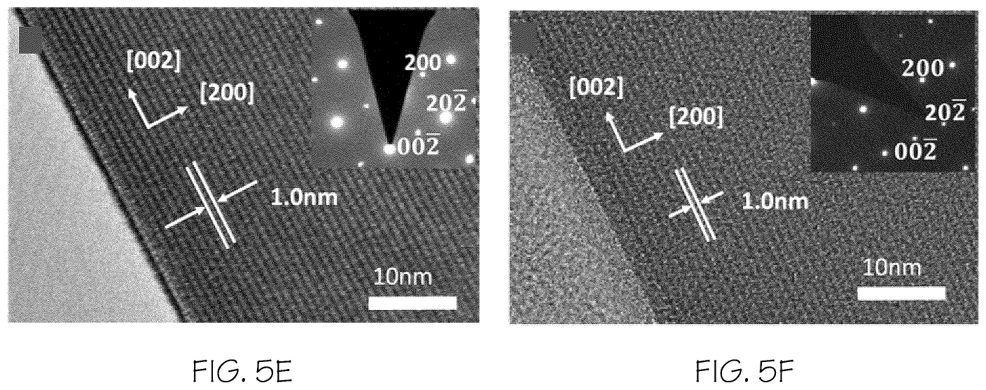

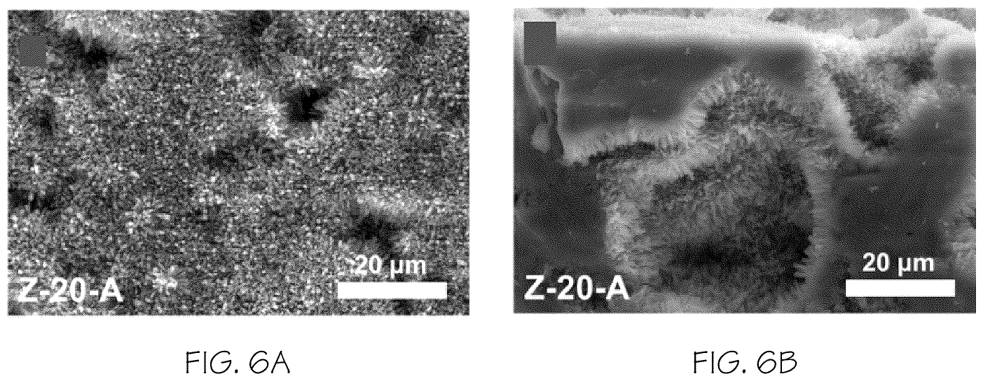

The c-oriented ZSM-5 films on cordierite were prepared using the secondary growth method. Two types of ZSM-5 films at Si/Al ratios of 80 and 20, denoted as ‘Z-80-F” and ‘Z-20-A”, were synthesized on the channeled cordierite monolith with assistance of pre-deposited silicalite-1 seeds. The ZSM-5 crystals are identified on both samples in the X-ray diffraction (XRD) pattern as shown in FIG. 3. Upon when the seeded monolith (FIG. 4B) is exposed to the synthesis solution at a Si/Al ratio of 80, a dense film is formed on the channel surface (Z-80-F, FIG. 5A) with highly intergrown crystals, similar to the reported conventional film morphology. However, when the Si/Al ratio decreases from 80 to 20, the ZSM-5 film morphology changes dramatically (FIG. 6), with the loading ratio decrease from 26.2 wt. % to 18.8 wt. % (Table 1). Instead of the crystal intergrowth, Z-20-A presents a unique array structure composed of vertically oriented ZSM-5 nanorods with well-preserved single crystal individually (FIG. 5B). Each ZSM-5 nanorod crystal is −200-400 nm in diameter and −3 μm in length. This array structure is further confirmed by the bright field transmission electron microscopy (TEM) image in FIG. 5D. The high-resolution TEM images and inset selective area electron diffraction (SAED) patterns in FIG. 5F indicate that the single-crystalline ZSM-5 nanorod in Z-20-A grows along (c-orientation).

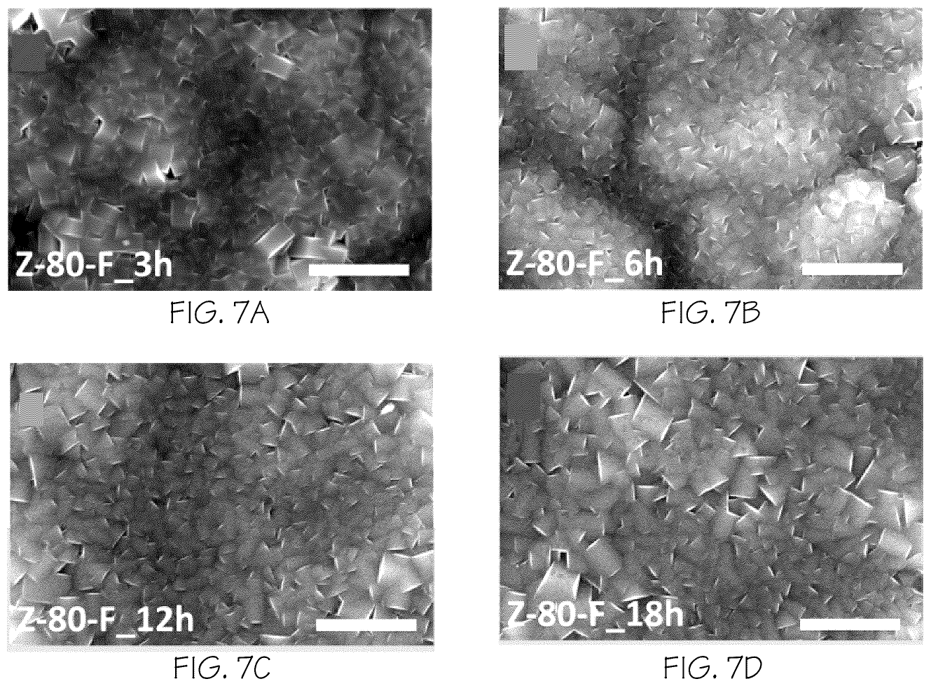

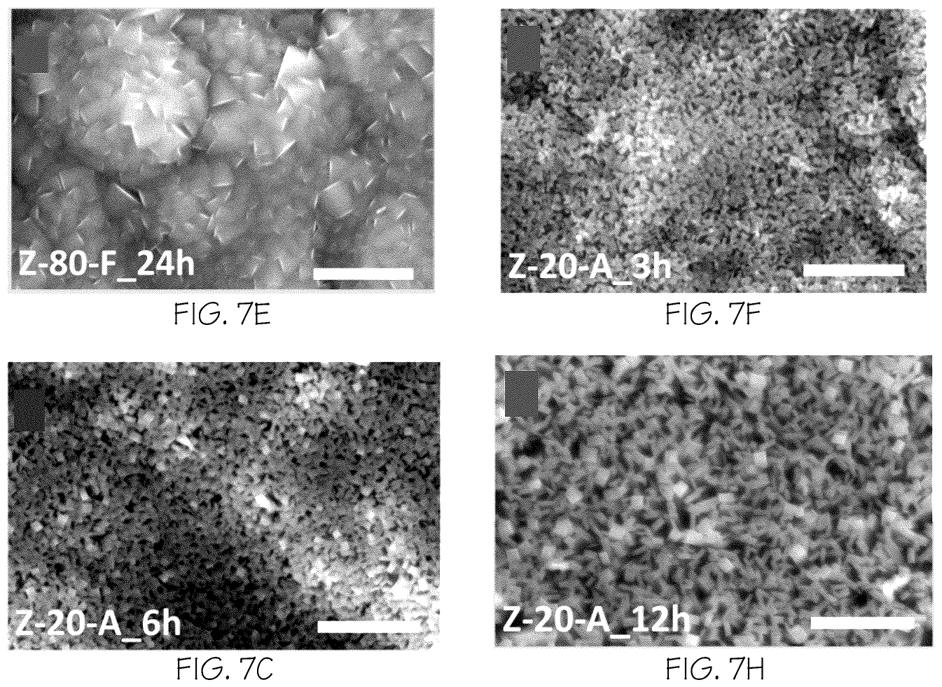

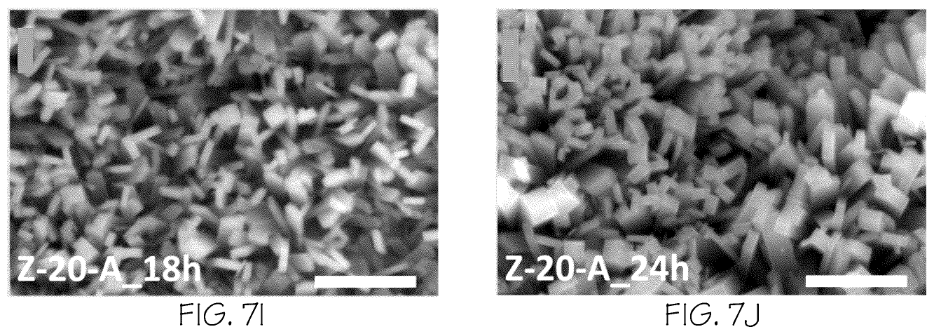

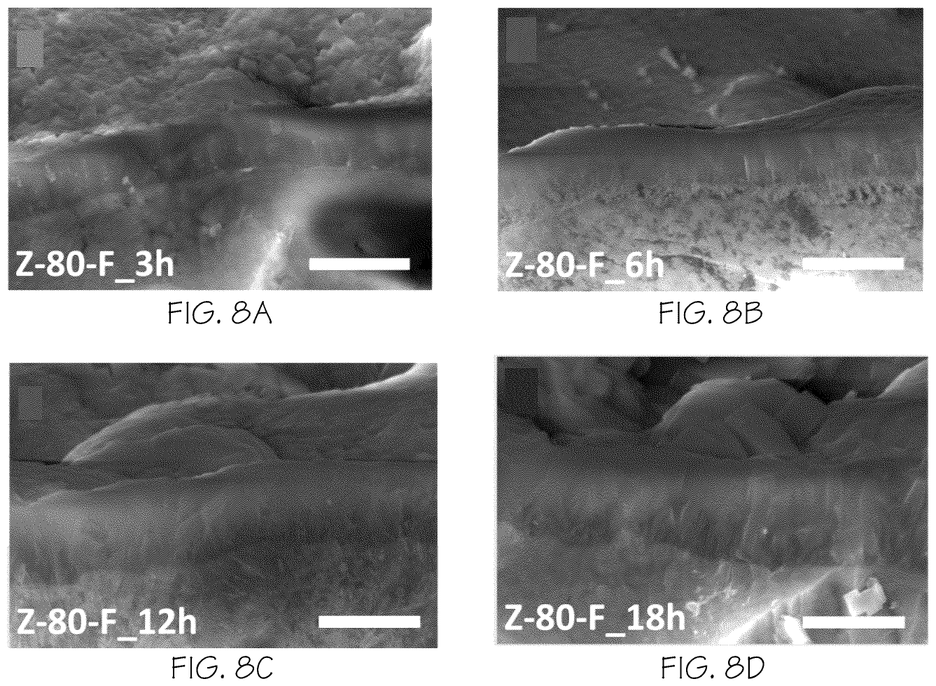

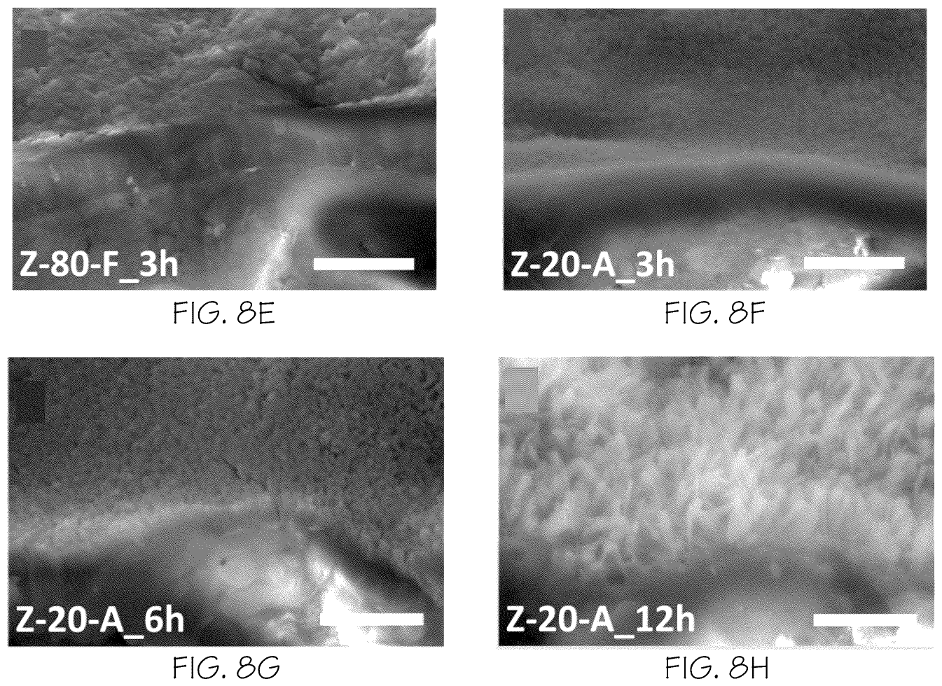

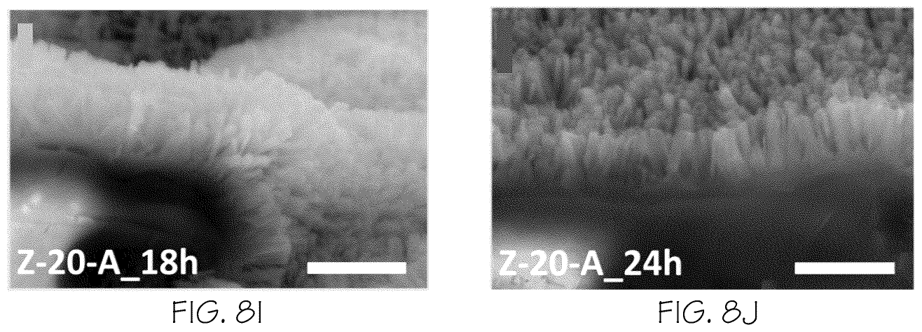

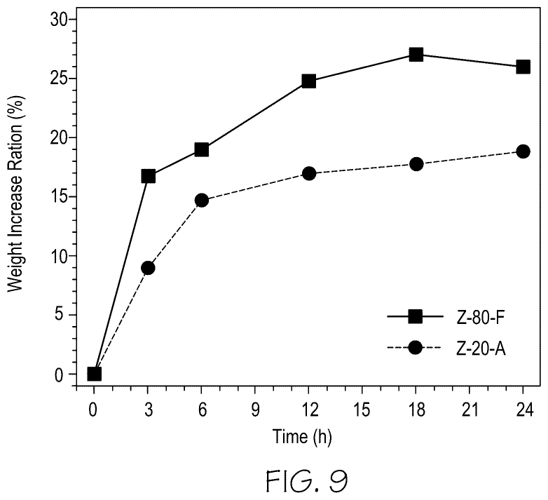

Samples synthesized at 180° C. for different times were prepared to investigate the growth habits of conventional continuous ZSM-5 film and array-structured ZSM-5 film, as summarized in the time-in-series SEM image galleries in FIG. 7-8 and weight change in FIG. 9. Unlike the crystal intergrowth quickly develops in the formation of a continuous ZSM-5 film in Z-80-F, the crystal individuality is preserved at the early growth stage of Z-20-A. The difference of film morphology and loading ratio in Z-80-F and Z-20-A may be strongly influenced by the Al ion concentration evolution in the synthesis solution. During the film growth, the negative charge resulted from the replacement of Si by Al in the tetrahedral units of ZSM-5 crystal could accumulate on the crystal surface. Since the MFI precursors in the synthesis solution are also negatively charged, the transport and attachment of nutrition particles to the equally charged crystal surfaces are hindered. Accordingly, abundant Al ions in the solution will not only retard the ZSM-5 crystallization, leading to a lower loading in Z-20-A, but also prevent the crystals from intergrowing into each other during synthesis process.

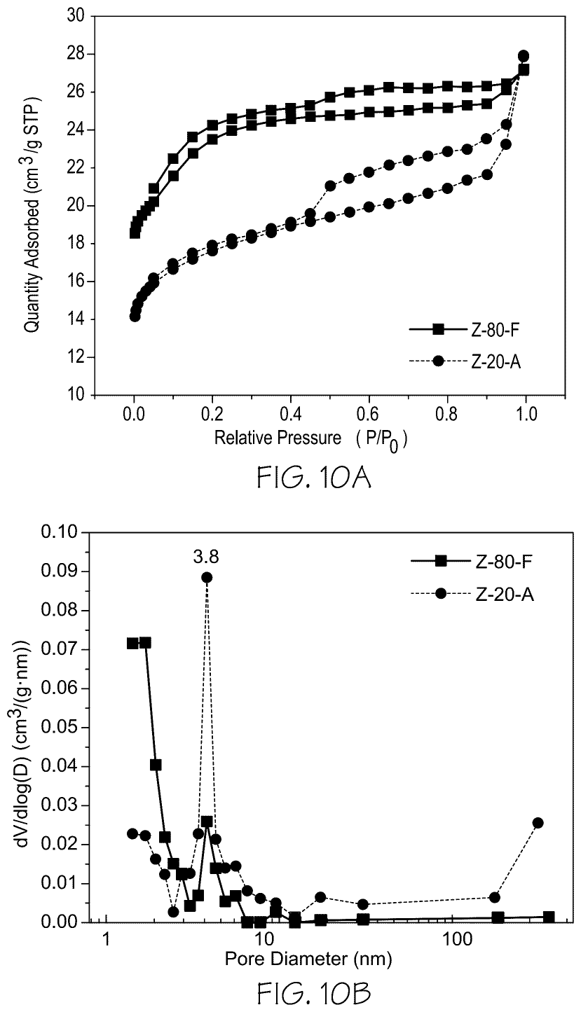

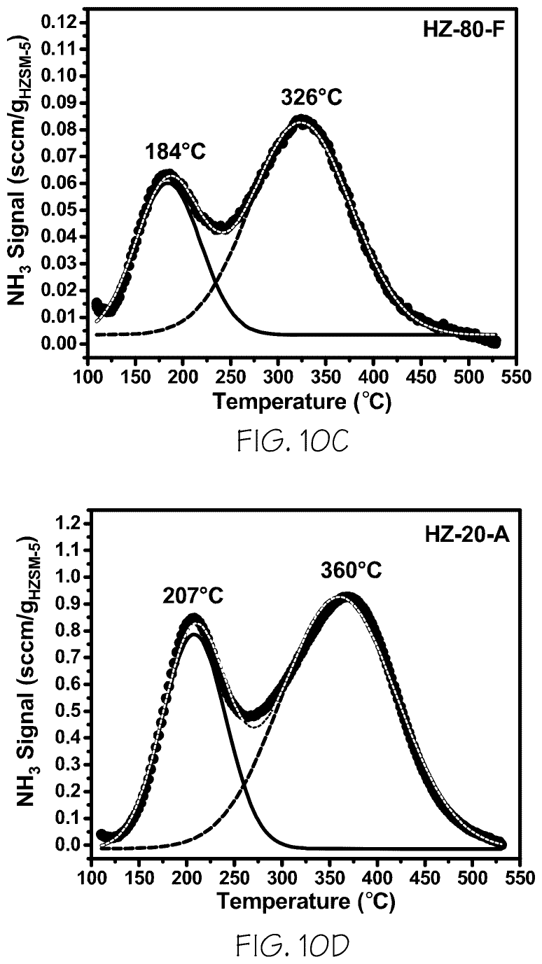

The unique array-structured morphology and lower Si/Al ratio would distinct Z-20-A from Z-80-F in different physicochemical properties. The N₂ adsorption-desorption isotherms displayed in FIG. 10 demonstrate that, compared to Z-80-F, Z-20-A shows a lower N₂ adsorption uptake at low pressures (P/P₀<0.45), a much larger area of hysteresis loop at a relatively high pressure (0.45<P/P₀<0.95), and an obviously enhanced uptake at high pressure (P/P₀>0.95). When the contribution from cordierite support is excluded, the array-structured ZSM-5 film exhibits a higher specific surface area of 344 m²g⁻¹. Especially, the external surface area increases from 99 m²·g⁻¹ in Z-80-F to 150 m²·g⁻¹ in Z-20-A. In addition, the results of derived BJH pore size distribution reveals that Z-20-A exhibits more mesopores and even macropores. As a result, despite of the similar total pore volume in both samples, the mesopore volume in Z-20-A is −47.4% higher than that in Z-80-F.

The presence of preferentially c-oriented nanorods in Z-20-A enables the pores and channels along a- and b-axes laterally parallel to the cordierite channel surface, facilitating the diffusion of reactant molecules. The higher specific surface area and mesopore volume in Z-20-A could further improve the diffusion and transportation of reactant molecules within the films, and boost their reaction dynamics. Conversely, the crystal intergrowth in Z-80-F may decrease the diffusion rates of reactants into and products out of the film, thus hindering the reactants accessibility to the surface active sites. Therefore, the unique array-structured ZSM-5 film is potentially advantageous to mitigate the kinetic restrictions during the adsorption of gaseous molecules such as HCs.

TABLE 1

| | | ZSM-5 | Crystallographic |
|---|---|---|---|
| | | Loading Ratio | Preferred Orientation |
| Sample | Si/Al | wt. % | CPO([002]/([200] + [020])) |
| Z-80-F | 83.5 | 26.2 | 0.82 |
| Z-20-A | 15.6 | 18.8 | 0.87 |

The atomic ratio of Si/Al is determined by the energy dispersive spectroscopy (EDS) that is combined with high-resolution transmission electron microscope (HRTEM)

TABLE 2

| | | | | | | | Strong | Propene |
|---|---|---|---|---|---|---|---|---|
| | | | | | | Weak Acid | Acid | Adsorption |
| | | | | | | Sites^{[c]} | Sites^{[c]} | Capacity^{[d]} |
| | S_{BET,Sample}_{^{[a]}} | S_{BET,ZSM-5}_{^{[b]}} | S_{Ext,ZSM-5}_{^{[b]}} | V_{total,Sample}_{^{[a]}} | V_{meso,Sample}_{^{[a]}} | mmol · g_{HZS} | mmol · g_{HZS} | μmol · mg_{HZS} |
| Sample | m² · g⁻¹ | m² · g⁻¹ | m² · g⁻¹ | cm³ · g⁻¹ | cm³ · g⁻¹ | M-5⁻¹ | M-5⁻¹ | M-5⁻¹ |
| Z-80-F | 84 | 325 | 99 | 0.042 | 0.019 | 0.22 | 0.47 | 0.92 |
| Z-20-A | 66 | 344 | 150 | 0.043 | 0.028 | 3.00 | 6.34 | 1.45 |

^{[a]}Cordierite substrates were included for the calculation of sample's surface area (S_{BET,Sample}), total pore volume (V_{total,sample}), and mesopore volume (V_{meso,Sample}) in the N₂ adsorption-desorption isothermal test.
^{[b]}The surface area of ZSM-5 film (S_{BET,ZSM-5}) was estimated by S_{BET,Sample} × Mass_{Sample} = S_{Bet,cordierite} × Mass_{Cordierite} + S_{Bet,ZSM-5} × Mass_{ZSM-5}. Similarly, as cordierite substrate barely contributed to the sample's external surface area, the external surface area of ZSM-5 film (S_{Ext,ZSM-5}) could by calculated by: S_{Ext,Sample} × Mass_{Sample} = S_{Ext,ZSM-5} × Mass_{ZSM-5}
^{[c]}The amounts of weak and strong acid sites were determined by ammonia temperature-programmed desorption (NH₃-TPD)
^{[d]}The propene adsorption capacity was calculated after 30 minutes of propene adsorption at 100° C.

A. Propene Adsorption Studies

Propene (C₃H₆) adsorption at low temperature is used as a probe reaction over proton-exchanged ZSM-5 film grown monolith samples (HZ-80-F and HZ-20-A), as evaluated in a homemade horizontal quartz tube reactor following the Low Temperature Storage Catalyst Test Protocol created by USDRIVE. It is noted that C₃H₆ molecules with a kinetic diameter of −4.95 Å can diffuse easily through internal porosity of MFI structure. The C₃H₆ adsorption capacity is related to the zeolite topology, specific surface area, Si/Al ratio, and the concentration and strength of acid sites. Moreover, the adsorbed C₃H₆ molecules could further react and oligomerize, leading to the formation of short- and long-chain hydrocarbons and coke during their catalytic oxidation process.

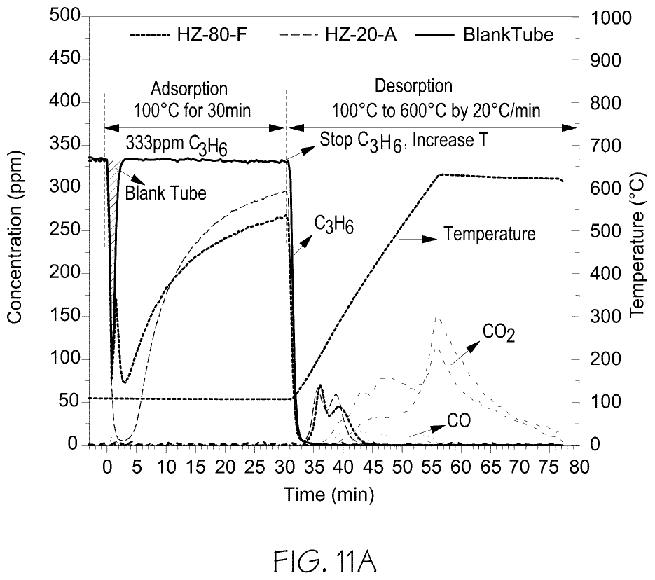

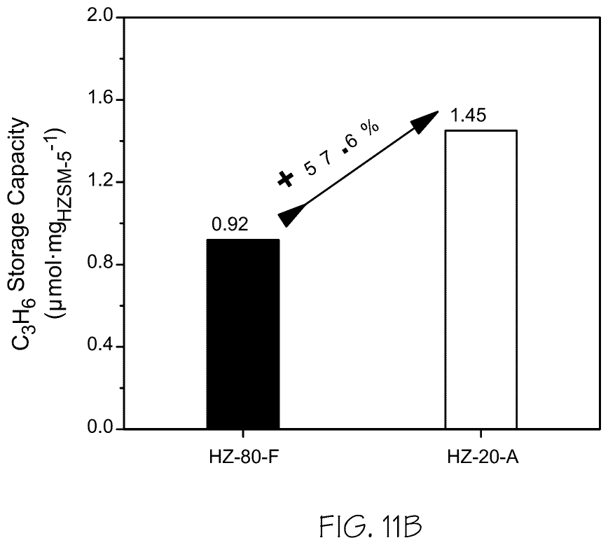

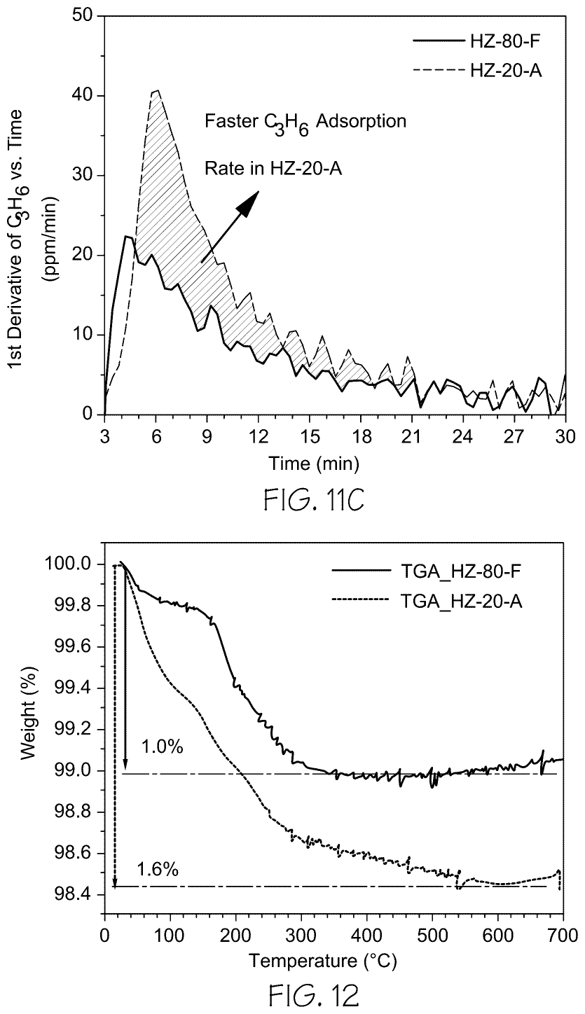

As revealed in FIG. 11A, both HZ-80-F and HZ-20-A samples are not saturated by C₃H₆ after 30 minutes of adsorption at 100° C. After being normalized by the mass of used HZSM-5, the specific C₃H₆ adsorption capacity of HZ-20-A is 1.45 μmol·mgHZSM-5⁻¹, 57.6% higher than that of HZ-80-F (FIG. 11B and Table 2). Such an enhancement in adsorption capacity in HZ-20-A could be attributed to a larger amount of acid sites associated with its lower Si/Al ratio, as determined by the results of ammonia temperature-programmed desorption test (NH₃-TPD, FIG. 10 and Table 2).

HZ-20-A has faster C₃H₆ adsorption kinetics at 100° C. than HZ-80-F. On one hand, upon exposure, HZ-20-A quickly adsorbs C₃H₆, making the C₃H₆ concentration it retains at a very low level for the first 5 minutes in the gas stream. On the contrast, HZ-80-F shows a delayed initial adsorption and is not able to sufficiently remove C₃H₆, as a result of an obvious diffusion barrier in the dense continuous film. On the other hand, the cross point in the C₃H₆ concentration profiles of both samples in the following adsorption time (t>5 min) implies a much faster C₃H₆ adsorption rate in HZ-20-A. Here the dynamic C₃H₆ adsorption rate was reflected by the first order derivative of propene concentration change. Due to the above-mentioned nearly-completed propene removal on HZ-20-A and delayed initial propene adsorption on HZ-80-F at first serval adsorption minutes, only the rates at t>5 min are compared and displayed in FIG. 11C. Evidently, HZ-20-A has a faster propene adsorption rate than HZ-80-F, as the ratio of propene adsorption rate in HZ-20-A over that in HZ-80-F is higher than 1 at most time. Therefore, HZ-20-A is of fast adsorption kinetics as a promising HC trap device for the short cold-start period.

After the adsorption for 30 min, C₃H₆ is removed from the feed gas while the temperature starts to increase from 100° C. to 600° C. As revealed in FIG. 11A, the adsorbed C₃H₆ is released from samples and oxidized in the temperature ramp stage, and the oligomerized species generated during adsorption will also be combusted. Here CO₂ is the major products while CO is negligible. With a larger amount of acid sites, HZ-20-A is supposed to contain more oligomerized products over HZ-80-F after 30-minute adsorption, as supported by a higher weight loss in TGA tests on the adsorbed samples (See FIG. 12). Correspondingly, HZ-20-A may generate more CO₂ than HZ-80-F throughout the test. However, the test results show that HZ-20-A yield less CO₂ and lower percentage of total generated CO₂ above 550° C. HZ-80-F sample. Considering the generated CO₂ at higher temperature is due to the combustion of long-chain HCs and coke, a less intensified oligomerization is suggested in HZ-20-A than HZ-80-F. This may be due to the enhanced diffusion of reactants in and reaction products out of the ZSM-5 nanoarrays enabled by c-oriented ZSM-5 nanorod crystals and unique array-structured morphology. Thus, such ZSM-5 array structure may help mitigate the long-chain HCs and coking formation during a chemical process in general.

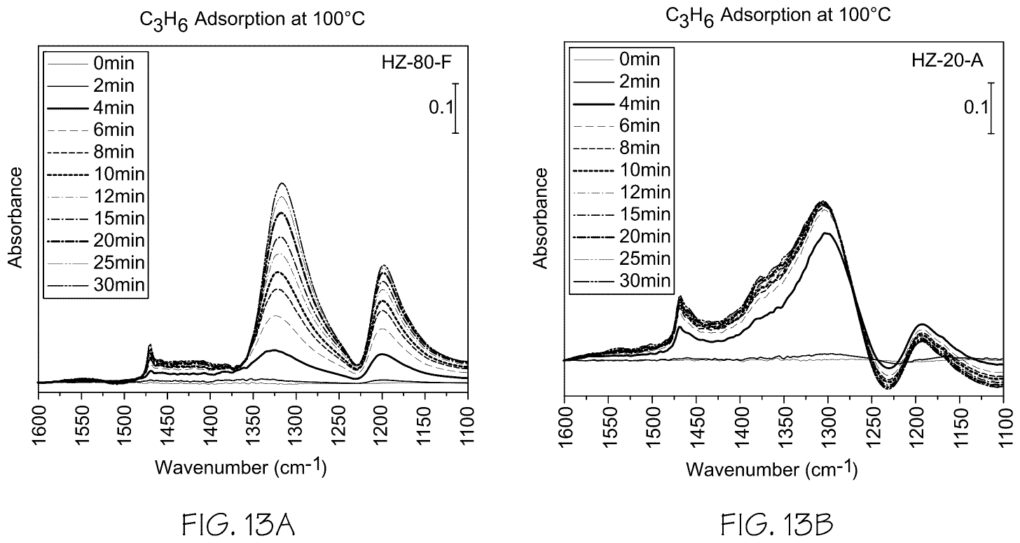

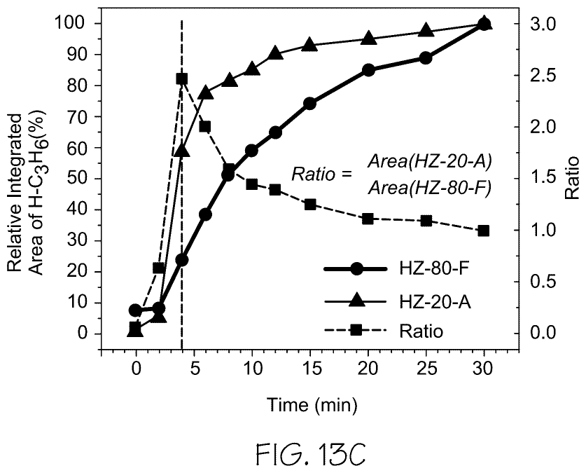

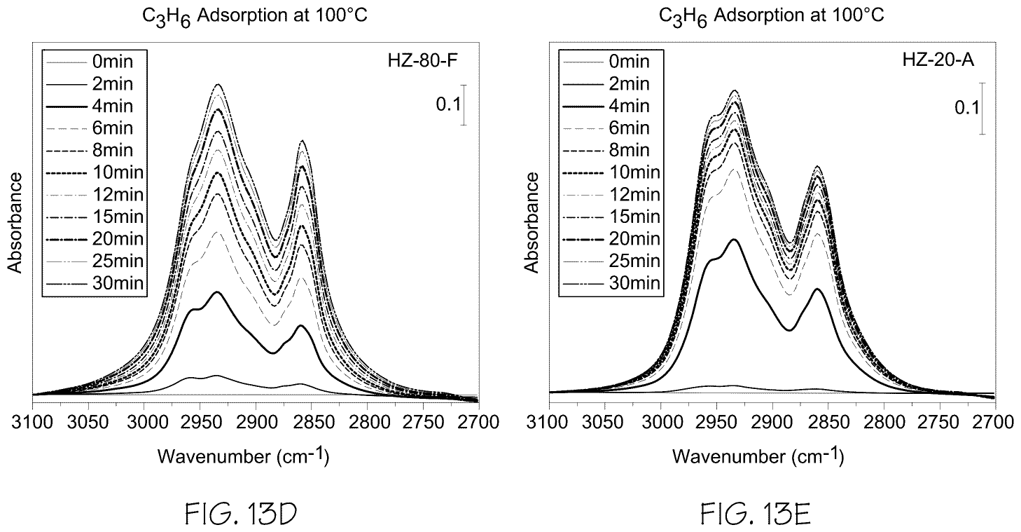

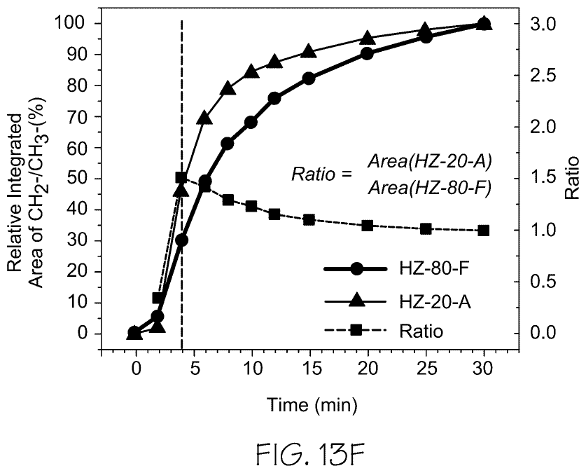

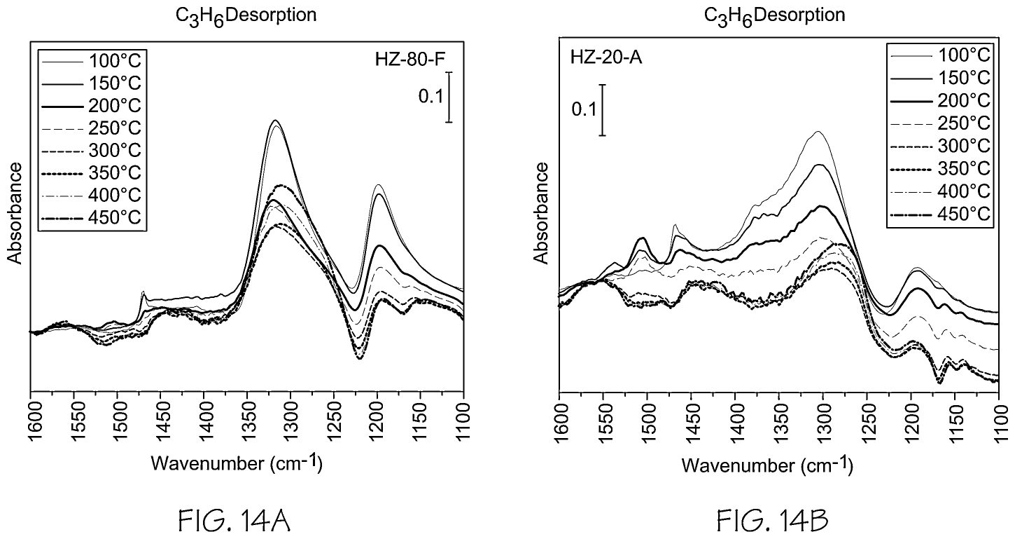

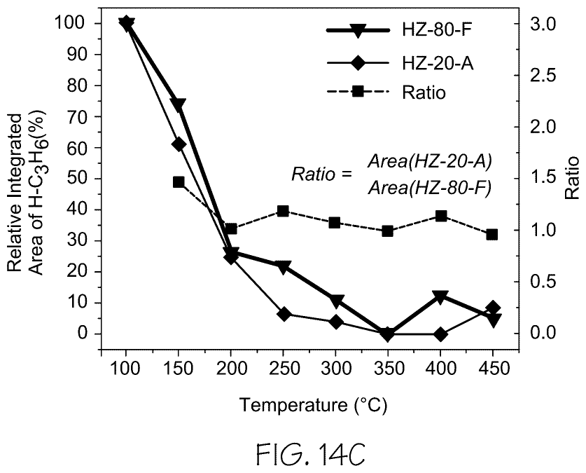

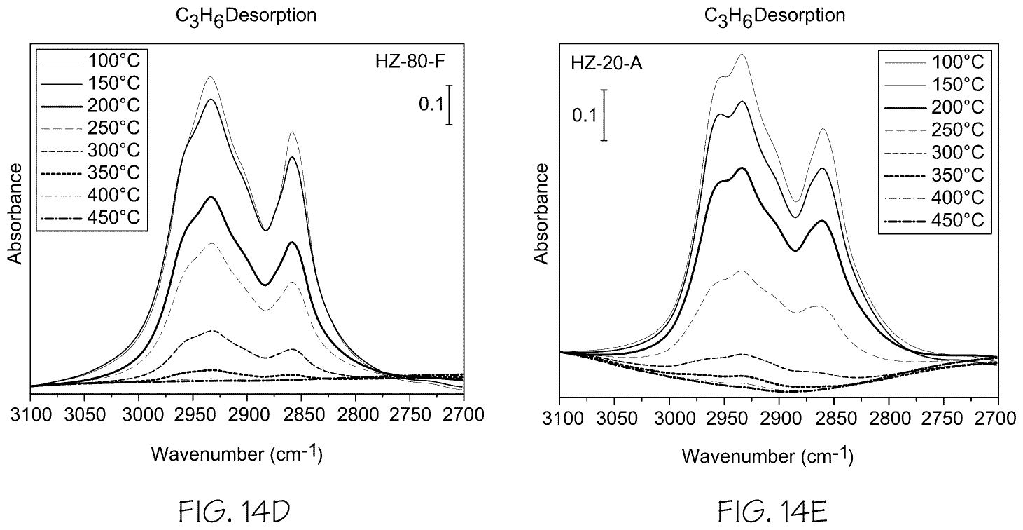

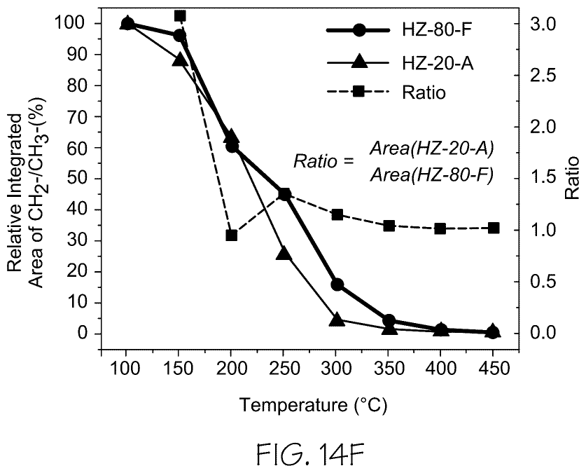

In-situ diffuse reflectance infrared Fourier transform spectroscopy (DRIFTS) was carried out to investigate the species on HZ-80-F and HZ-20-A samples during C₃H₆ adsorption and desorption process (See FIG. 13 and FIG. 14). The peak at 1470 cm⁻¹ is caused by the vibration of H—C₃H₆ adsorbed via their π bonds, and the peaks at 3080-2750 cm⁻¹ are assigned to the vibration of CH₂— and CH₃— groups due to oligomerization. It is found that the peak areas of H—C₃H₆ and CH₂—/CH₃-in HZ-80-F and HZ-20-A are increasing gradually with adsorption time. By integrating the peak areas of H—C₃H₆ and CH₂—/CH₃— and setting the integrated values at 30 min as references, the increasing rate of each species in both samples can be roughly quantified. Thus, the faster rates of both C₃H₆ adsorption and oligomerization are clearly proved in HZ-20-A. For instance, at t=4 min in FIG. 13, the relative integrated areas of H—C₃H₆ and CH₂—/CH₃-in HZ-20-A are −2.5 and −1.5 times over those in HZ-80-F, respectively. Following the similar approach, faster rates of H—C₃H₆ desorption and decomposition of alkoxide moieties could also be demonstrated during the temperature ramp in HZ-20-A when referred to the peak area at T=100° C.

B. HCs Removal Studies

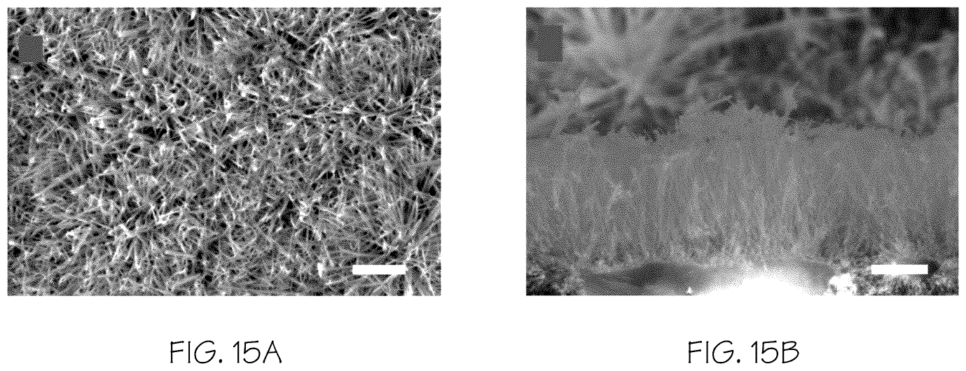

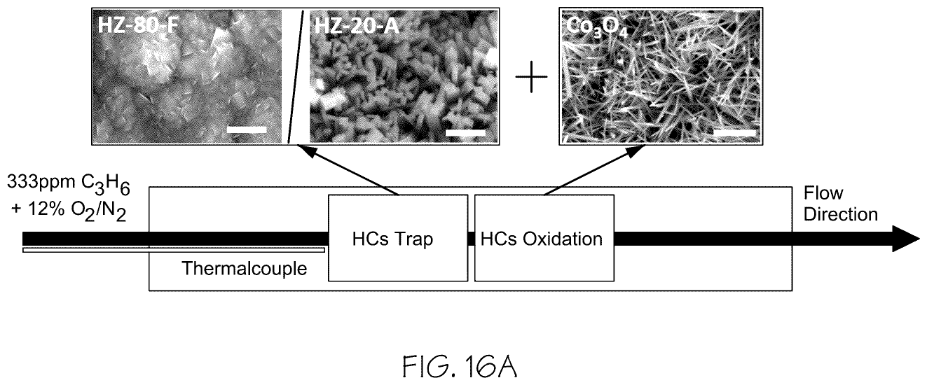

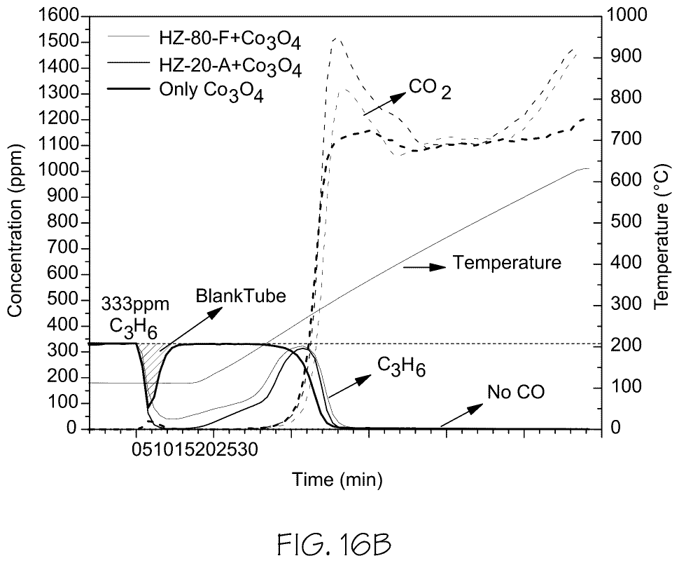

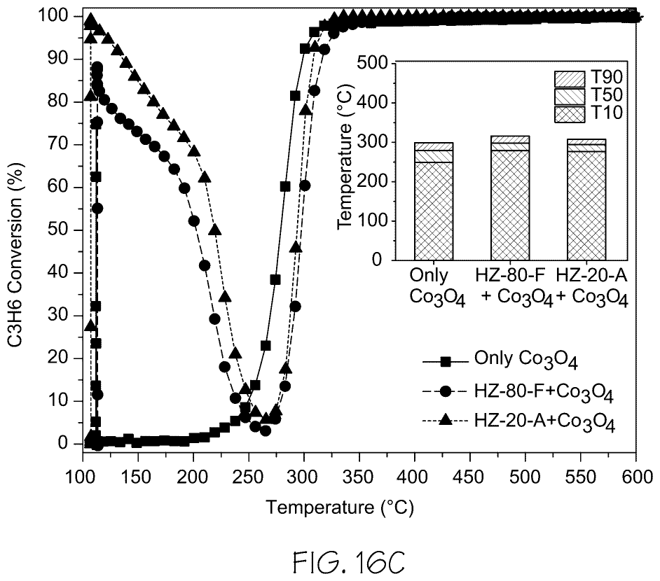

To validate the advantages of HZ-20-A design in HC removal, especially for a short duration at low temperature, propene gas mixture was sequentially passed through a dual-bed reactor system including a propene trap (i.e., HZ-80-F or HZ-20A) and a propene oxidation catalyst (i.e., Co₃O₄ nanoarray, FIG. 15) following the cold-start test (CST) protocol. The reactor was maintained at 100° C. for 3 min and then heated to 600° C. at a ramp rate of 20° C.·min⁻¹. From the CST results as illustrated in FIG. 16, the Co₃O₄ nanoarray could catalytically oxidize C₃H₆ into CO₂ starting from −200° C., but its propene adsorption capability is negligible at lower temperatures. Instead, the presence of either HZ-80-F or HZ-20-A in front of Co₃O₄ could significantly improve the C₃H₆ removal efficiency at T<200° C. when Co₃O₄ is not thermally activated. No CO was detected throughout all the tests. Compared to HZ-80-F+Co₃O₄, HZ-20-A+Co₃O₄ could completely remove C₃H₆ at 100° C. for the dwelling time of 3 min, and exhibited a similar T90 temperature where 90% of C₃H₆ was completely oxidized to that when only Co₃O₄ is used at the oxidation stage. Thus, the nanorod array-structured design in ZSM-5 adsorber offers a promising route to reduce hydrocarbons emission during the short cold-start period at low temperatures while retaining the downstream oxidation catalyst activity.

III. ZSM-5 Co₃O₄ Hybrid Nanoarrays

Multifunctional catalysts integrated into one device have been developed to achieve multiple catalytic functions on a single device. The integration of ZSM-5 nano-arrays with metal-oxide (i.e., Co₃O₄) nano-arrays could be fabricated on ceramic substrates such as cordierite honeycombs, forming one-device hybrid structured nano-array monoliths. FIG. 17 shows the synthesis process of hybrid structured ZSM-5 and Co₃O₄ nano-array and their individual component on cordierite honeycomb substrate. The synthesis of hybrid structured nano-array monoliths is completed by the sequential growth of ZSM-5 nano-array via secondary growth method and Co₃O₄ nano-array via in-situ hydrothermal method. The two different configurations in hybrid nano-array system are prepared by adjusting the growth sequence of each component. Clearly, hybrid Cordierite/ZSM-5/Co₃O₄ nano-array exhibits a dual-layered configuration with H-ZSM-5 nanorod on bottom and Co₃O₄ nanowire on top. At low temperature, hydrocarbons (i.e., propene) could pass through the top Co₃O₄ nanowire layer and be captured by the bottom H-ZSM-5 nanorod layer. When the temperature increases, the released carbon species from the bottom H-ZSM-5 nanorod layer will be immediately oxidized by the top Co₃O₄ nanowire layer. On the other hand, another hybrid Cordierite/Co₃O₄/ZSM-5 nano-array displays a novel brush-like structure with Co₃O₄ nanowire as cores and H-ZSM-5 nanorod as branches, leading to the highest propene capture capacity among all samples.

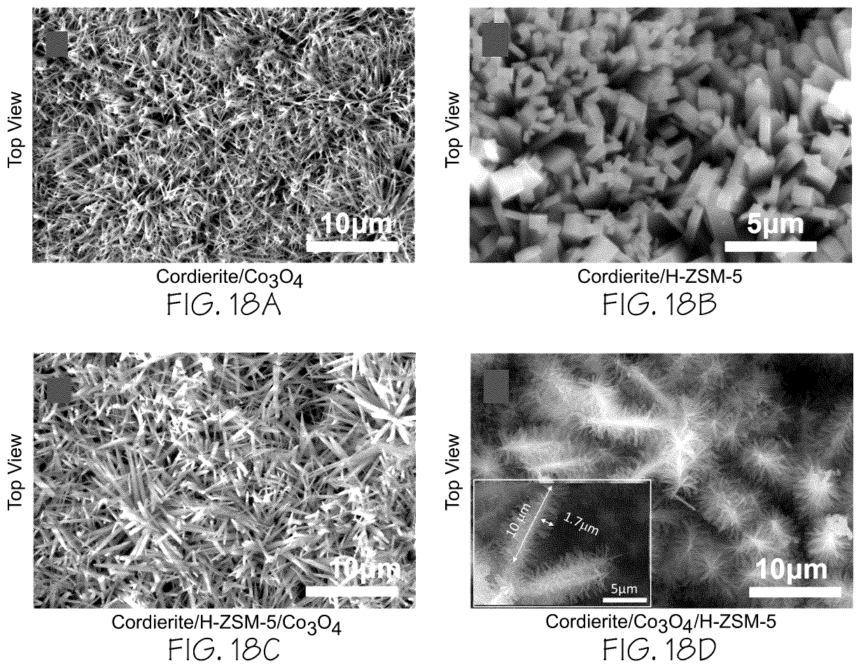

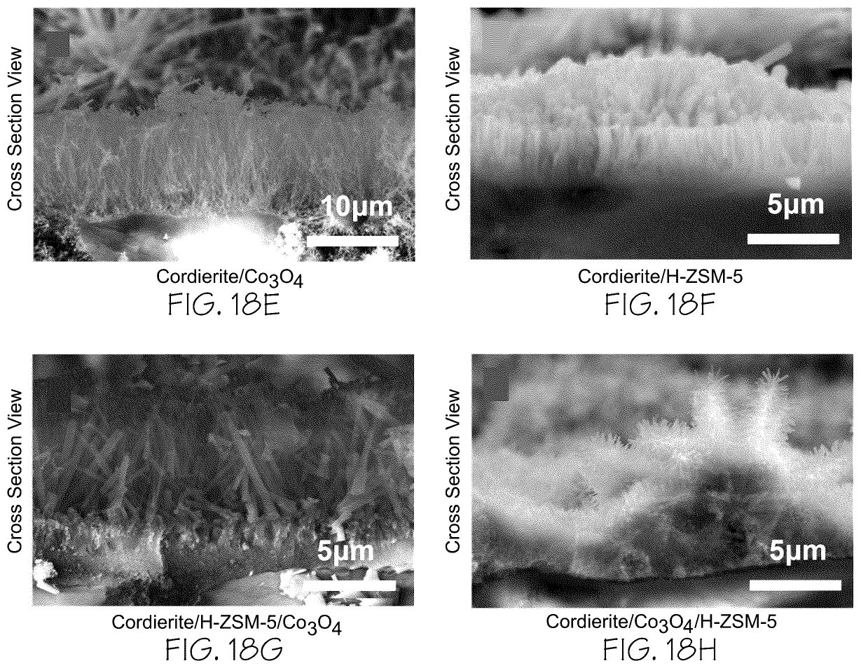

FIG. 18 shows representative SEM images from (FIG. 18A-D) top view and (FIG. 18E-H) cross-sectional view of as-prepared (FIG. 18A, FIG. 18E) Cordierite/Co₃O₄ nano-array, (FIG. 18B, FIG. 18F) Cordierite/ZSM-5 nano-array, (FIG. 18C, FIG. 18G) hybrid Cordierite/ZSM-5/Co₃O₄ nano-array, and (FIG. 18D, FIG. 18H) hybrid Cordierite/Co₃O₄/ZSM-5.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other compositions and methods for carrying out the several purposes of this disclosure. As a result, the claims should not be considered as limited by the description or examples.

What is claimed is:

1. A solid porous composite material comprising:
an array of pentasil-zeolite crystals on a surface of a substrate, the array of pentasil-zeolite crystals being oriented elongate along a longitudinal c-axis that is generally perpendicular to the surface of the substrate;
wherein the array of pentasil-zeolite crystals defines a plurality of a-channels and a plurality of b-channels;
wherein the plurality of b-channels have a first flow path that is generally parallel to the surface of the substrate; and
wherein the plurality of a-channels have a second flow path that follows an axis that crosses and is generally perpendicular to the first flow path.

2. The solid porous composite material of claim 1, wherein the substrate is a monolithic catalyst support.

3. The solid porous composite material of claim 1, wherein the array of pentasil-zeolite crystals has an individual crystal diameter ranging from 10 nm to 500 nm.

4. The solid porous composite material of claim 1, wherein the array of pentasil-zeolite crystals has an individual crystal length ranging from 100 nm to 10 μm.

5. The solid porous composite material of claim 1, wherein the array of pentasil-zeolite crystals constitutes 1% to 30% by weight of the solid porous composite material.

6. The solid porous composite material of claim 1, wherein the array of pentasil-zeolite crystals has a specific surface area of 300 m²/g to 400 m²/g.

7. The solid porous composite material of claim 1, wherein the array of pentasil-zeolite crystals has an external surface area of 100 m²/g to 200 m²/g.

8. The solid porous composite material of claim 1, wherein the array of pentasil-zeolite crystals has a mesopore volume of 0.02 cm³/g to 0.4 cm³/g.

9. The solid porous composite material of claim 1, further comprising an array of a metal oxide having channels in fluid communication with the plurality of a-channels and the plurality of b-channels of the array of pentasil-zeolite crystals.

10. The solid porous composite material of claim 9, wherein the array of pentasil-zeolite crystals is between the surface of the substrate and the array of the metal oxide.

11. The solid porous composite material of claim 9, wherein the metal oxide comprises a cobalt oxide, a titanium oxide, a titanate, a nickel oxide, a cerium oxide, a gallium oxide, a magnesium oxide, a manganese oxide, or a zinc oxide.

12. A method of preparing a solid porous composite material, the method comprising:
a) providing a seeded substrate;
b) contacting the seeded substrate with a mixture comprising an alkoxide of silicon and an aluminate at a molar ratio of 10:1 to 30:1 (alkoxide of silicon:aluminate) under conditions sufficient to form the solid porous composite material.

13. The method of claim 12, wherein the seeded substrate is a seeded monolithic catalyst support.

14. The method of claim 12, wherein the seeded substrate is seeded with a silicon dioxide.

15. The method of claim 12, wherein the mixture comprises a peptizing agent.

16. The method of claim 15, wherein the alkoxide of silicon and the peptizing agent are present at a molar ratio ranging from 90:1 to 5:1 (alkoxide of silicon:peptizing agent).

17. The method of claim 12, wherein the mixture comprises a hydrolyzing agent.

18. The method of claim 17 wherein the alkoxide of silicon and the hydrolyzing agent are present at a molar ratio of up to 1:0.6 (alkoxide of silicon:hydrolyzing agent).

19. A method of removing a hydrocarbon from a fluid, the method comprising contacting the fluid with the solid porous composite material of claim 1 under conditions sufficient to adsorb the hydrocarbon onto the solid porous composite material.

20. The method of claim 19, further comprising trapping the hydrocarbon or a reaction product thereof.
